(19) United States
(12) Patent Application Publication
(10) Pub. No.: US 2023/0285781 A1
(43) Pub. Date: Sep. 14, 2023

(54) Modular Reusable Elastomeric Half-Face Respirator

(71) Applicant: Open Standard Industries, Inc., Holyoke, MA (US)

(72) Inventors: Matthew Eli Carney, Portland, OR (US); Aaron Garden Cantrell, Easthampton, MA (US); Philip Jayson Brown, Winston-Salem, NC (US); Jesse Jarrell, Corbett, OR (US); Che-Wei Wang, Brooklyn, NY (US); Jake Horsey, Easthampton, MA (US); Stephanie Whalen, San Francisco, CA (US); David Carlberg, Portland, OR (US)

(21) Appl. No.: 18/007,237

(22) PCT Filed: Apr. 15, 2021
(86) PCT No.: PCT/US2021/027524

§ 371 Date: Jan. 27, 2023

Related U.S. Application Data
(60) Provisional application No. 63/057,695, filed on Jul. 28, 2020.

(51) Int. Cl. A62B 18/02; A62B 23/02; A62B 18/08

(52) U.S. Cl. CPC A62B 18/025; A62B 23/02; A62B 18/084

(57) ABSTRACT

A modular reusable elastomeric half-face respirator device includes a modular housing and an elastomeric facepiece. The respirator device can include one or more modular straps, which can be coupled to the filter housing or the facepiece. The modular housing includes a modular filter component configured to hold filter media and to couple to the facepiece. A filter retention mechanism includes an interlocking bayonet-type ratcheting ramp configured to form a seal around the modular filter component, the filter media, or both. The facepiece can include an interfacing portion configured to seal to the face of a person wearing the respirator device, the interfacing portion having a geometry with an outward curvature allowing the interfacing portion to seal to the face by rolling back and increasing contact area between the facepiece and the face. A lock ring receivable in a port of the facepiece can couple the facepiece to the filter component.

### RELATED APPLICATION

This application claims the benefit of U.S. Provisional Application No. 63/057,695, filed on Jul. 28, 2020. The entire teachings of the above application are incorporated herein by reference.

### BACKGROUND

Certain facial respirators may include one or more parts that are not reusable, such as a filter. As one example, some facial respirators may include an insertion point for a disposable filter. Some facial respirators may be used to protect a wearer from airborne particulates or pathogens. However, while some facial respirators may include filters, the effectiveness, durability, comfort, and longevity, provided by such filters may suffer due to inflexible designs. Certain facial respirators may require a certain type or thickness of a filter, valves that need to be released and/or cleared, seals that can fail over time, fixed positions that can cause discomfort or poor fitment, etc. For example, many current industrial respirators, N95 disposable respirators, or other types of face-masks may include check-valves, which fundamentally limit the effectiveness of infection control by releasing unfiltered breath exhalation. These flaws can cause a wearer, or even people nearby, to be exposed to harmful pathogens.

### SUMMARY

This disclosure relates generally to elastomeric facial respirator devices. More specifically, but not by way of limitation, this disclosure relates to modular reusable elastomeric half-face respirators.

Certain aspects involve a reusable elastomeric filtering facepiece respirator (FFR), e.g. an air purifying respirator (APR), described herein and described as the Open Standard Respirator (OSR) Model 1 (OSR-M1), which can provide a low-cost, modular and filter-media agnostic respirator designed specifically to protect against particulates, and known and emerging airborne pathogens. Specifically, certain aspects involve a modular reusable elastomeric half-mask respirator device. One example reusable respirator device includes a modular elastomeric half-mask facepiece element and a rigid filter housing or cartridge. In this example, the modular housing attaches to an elastomeric facepiece element by way of a fixturing lock ring element. Further, the modular device includes one or more modular straps coupled to the elastomeric facepiece element, to the modular housing, or an intermediary component. Additionally, the modular housing includes a modular filter component to couple to the elastomeric facepiece element. The modular filter component includes a filter retention mechanism. The filter retention mechanism includes an interlocking bayonet-type ratcheting ramp configured to form a seal around the modular filter component.

Other aspects described herein involve a modular reusable elastomeric half-mask facial respirator device. For example, one respirator device includes a housing, an elastomeric facepiece element, one or more sensor(s) coupled to the elastomeric facepiece element, or the modular filter component coupled to the elastomeric facepiece element. In this example, the modular filter component includes a filter retention mechanism. The filter retention mechanism may be capable of forming a seal around the modular filter component. The facepiece retention mechanism may be capable of forming a seal between the facepiece and housing elements. The modular facepiece element may exist in multiple forms and sizes, each of which can be attached to the rigid filter housing. Certain physical design elements of the modular facepiece provide structure and seal to the face of a wearer. Ridge elements in the facepiece design may provide adaptable stiffness to the facepiece structure for face-seal interfaces, and in addition to geometry helping to locate to the face of a wearer, and to the modular housing.

Certain other aspects described herein involve a computing system for monitoring a modular reusable respirator device. For example, one computing system includes a processing device and a non-transitory computer-readable medium communicatively coupled to the processing device and storing program code. The processing device can be configured to execute the program code and thereby perform operations that include sampling sensor signal(s) from one or more sensor(s) configured to sense an environmental or biometric condition associated with a modular elastomeric respirator device. Further, operations include analyzing sensor data associated with the sensor signal. Operations further include determining a change in the environmental or biometric condition based on a change in the sensor data over time. Additionally, operations include generating, for display, a notification based on the change in the environmental or biometric condition. Other computing systems may include a microphone that can detect, collect, and transmit an ambient noise level, speech, or a voice of the user. A speaker or other audio playback device may also be included. In some examples, the microphone and/or audio playback device may be an analog, digital, or any other suitable type of microphone and/or audio playback device.

An example modular reusable respirator device includes: an elastomeric facepiece; a filter adapter configured to couple to the facepiece; a filter grill configured to couple to the filter adapter, the filter grill and the filter adapter cooperating to house a filter media component sealed between the filter adapter and filter grill; and a filter retention mechanism, the filter retention mechanism including an interlocking bayonet-type ratcheting ramp configured to provide a sealing pressure around the filter media component.

An example modular reusable respirator device includes: an elastomeric facepiece; a filter adapter configured to couple to the facepiece; a locking element configured to secure the elastomeric facepiece to the filter adapter by a facepiece retention mechanism, the facepiece retention mechanism including an interlocking bayonet-type ratcheting ramp configured to provide a sealing pressure; a filter media component receivable in the filter adapter; and a filter grill configured to couple to the filter adapter and secure the filter media element by a filter retention mechanism, the filter retention mechanism including an interlocking bayonet-type ratcheting ramp configured to provide a sealing pressure around the filter media component.

An example interface system for a modular device, including an elastomeric facepiece and a device adapter, includes: an elastomeric facepiece including a facepiece port; a device adapter configured to couple to the facepiece port; a lock ring receivable in the facepiece port and configured to secure the facepiece to the filter adapter via a facepiece retention mechanism, the facepiece retention mechanism including an interlocking bayonet-type ratcheting ramp configured to provide a sealing pressure at the facepiece port.

An example modular facepiece for a device includes an elastomeric facepiece body including an interfacing portion configured to seal to the face of a person wearing the device, wherein the interfacing portion has a geometry with an outward curvature, the outward curvature allowing the interfacing portion to seal to the face of the person wearing the device by rolling back and increasing contact area between the facepiece and the face. The facepiece includes a port configured to couple to a device adapter of the device.

In any of the modular reusable respirator devices, an exhaust valve may be integrated into the filter adapter, oriented off-center and directing exhaust air generally away from the filter adapter, e.g., in a direction of a wearer of the device.

These illustrative examples are mentioned not to limit or define the disclosure, but to aid understanding thereof. Additional aspects are discussed in the Detailed Description, and further description is provided there.

### BRIEF DESCRIPTION OF THE DRAWINGS

The foregoing will be apparent from the following more particular description of example embodiments, as illustrated in the accompanying drawings in which like reference characters refer to the same parts throughout the different views. The drawings are not necessarily to scale, emphasis instead being placed upon illustrating embodiments.

FIG. 1 depicts a side view of an example of a modular reusable elastomeric half-face respirator, according to certain aspects of this disclosure.

FIG. 2 depicts a perspective view of the modular reusable elastomeric half-face respirator of FIG. 1, according to certain aspects of this disclosure.

FIG. 3 depicts a side view of the modular reusable elastomeric half-face respirator of FIG. 1, shown without straps, according to certain aspects of this disclosure.

FIG. 4 depicts an exploded view of the modular reusable elastomeric half-face respirator of FIG. 3, according to certain aspects of this disclosure.

FIG. 5 depicts a perspective view of the modular reusable elastomeric half-face respirator of FIG. 3, according to certain aspects of this disclosure.

FIG. 6 depicts a rear view of the modular reusable elastomeric half-face respirator of FIG. 3, according to certain aspects of this disclosure.

FIG. 7 depicts a front view of the modular reusable elastomeric half-face respirator of FIG. 3, according to certain aspects of this disclosure.

FIG. 8 depicts another front view of the modular reusable elastomeric half-face respirator of FIG. 3, according to certain aspects of this disclosure.

FIG. 9 depicts a cross-sectional view of the modular reusable elastomeric half-face respirator of FIG. 8, according to certain aspects of this disclosure.

FIG. 10 depicts a detail view of FIG. 9, illustrating an example of a compression seal for a modular reusable elastomeric half-face respirator, according to certain aspects of this disclosure.

FIG. 11 depicts a detail view of FIG. 9, illustrating an example of a filter grill for a modular reusable elastomeric half-face respirator, according to certain aspects of this disclosure.

FIG. 12 depicts a perspective view of an example of a head harness assembly for a modular reusable elastomeric half-face respirator, according to certain aspects of this disclosure.

FIG. 13 depicts a top view of the adjustable headband of the example head harness of FIG. 12, shown unfolded, according to certain aspects of this disclosure.

FIG. 14 depicts a perspective view of the neck strap clip of the example head harness of FIG. 12, according to certain aspects of this disclosure.

FIG. 15 depicts another example of a modular reusable elastomeric half-face respirator including a head-harness strap that is made of elastomeric or elastic fabric, according to certain aspects of this disclosure.

FIG. 16 depicts a perspective view of the respirator device of FIG. 15 illustrating an alternate head-harness strap and assembly.

FIG. 17 depicts an example of a respirator device including a facepiece illustrating geometry on the facepiece to locate and seal on a human face.

FIG. 18 depicts an example of a facepiece illustrating geometry on the facepiece to locate on the modular housing and to the face.

FIG. 19 depicts a cutaway view of the example facepiece of FIG. 18.

FIG. 20 depicts an example of indexing features between modular components illustrating the facepiece and filter adapter of a modular reusable elastomeric half-face respirator.

FIG. 21 depicts a cut-away view of an example of a respirator device illustrating ramped ratchet features on components of the device.

FIG. 22 further depicts an example of ramped ratchet features on a lock ring and a filter adapter.

FIG. 23 depicts an example of a head-harness strap adjustment clasp component.

FIG. 24 depicts a cross-section view of the head-harness strap of FIG. 23.

FIG. 25 schematically depicts a change in pressure profile through the filter adapter, according to certain aspects of this disclosure.

FIG. 26 depicts an example auxiliary sensor area on a facepiece, according to certain aspects of this disclosure.

FIG. 27 depicts another example of a filter cartridge assembly mounted to a facepiece.

FIG. 28 depicts an example of a computing environment for monitoring a modular reusable elastomeric half-face respirator, according to certain aspects of this disclosure.

FIG. 29 depicts an example of a process for monitoring a modular reusable elastomeric half-face respirator, according to certain aspects of this disclosure.

FIG. 30 depicts an example of a computing system for implementing one or more aspects of this disclosure.

FIG. 31 depicts an example filter adapter that includes an exhalation port, according to certain aspects of this disclosure.

FIG. 32 depicts a section view of the filter adapter of FIG. 31.

FIG. 33 depicts a detail view of the filter adapter of FIG. 32.

### DETAILED DESCRIPTION

A description of example embodiments follows.

Certain aspects involve a reusable elastomeric filtering facepiece respirator (FFR) or air-purifying respirator (APR) described herein and described as the Open Standard Respirator (OSR) Model 1 (OSR-M1), which provides a low-cost, modular and filter-media agnostic respirator device designed specifically to protect against particulates, gas, vapor, or known and emerging airborne pathogens. Advantageously, the modular adaptability of embodiments according the present invention may allow for a wider option of filter media to be used in the present invention. In some examples, this added flexibility may ensure usability with the facial respirator based on an availability of available filters. For instance, certain aspects involve modular reusable elastomeric components that adds such flexibility by avoiding using the facial respirator as both a structural element and a filtration element, reducing the amount of filter media required to provide functionality. Further advantage of the modular invention is the ability to fit multiple facepiece elements, providing means to fit a wide population of face geometries from children to adults of different nationalities.

Development of an OSR-M1 device has been chronicled on the website entitled “MASKproject: Open standard respirator, N95 alternative face mask” (available online at www.media.mit.edu/projects/maskproject/overview/) as early as Apr. 12, 2020.

The following non-limiting example is provided to introduce certain aspects. In one example, the present invention may include a bi-directional filtration technique to improve infection control for both the wearer and people nearby (e.g., adjacent or proximate to the wearer). Further, the invention may include modular adaptability for different filtration grades (N95, N99, to N100 or other levels of limited particle penetration), filtration types (particulate, oils, organic vapor, gases, etc.), future upgradeability, etc. And in some examples, using elastomeric materials to create the structure and shape of the device reduces the amount of filter material required for use in an individual device, thus reducing the demand on filter supply chains. And in some examples, using elastomeric materials to create the structure and shape of the device reduces the amount of filter material required for use in an individual device, thus reducing the demand on filter supply chains.

For example, the modular facial respirator may include a reusable elastomeric half-face respirator device. In one example, the reusable elastomeric half-face respirator includes a reusable elastomeric half-face air purifying respirator (APR). In this example, the reusable elastomeric APR includes one or more structural elements that are capable of securely housing a filtration element. In some examples, the reusable elastomeric APR may employ a substantially modular design that includes one or more changeable (e.g., upgradeable or replaceable) structural elements.

For instance, changeable structural elements may include modular parts of the reusable elastomeric APR. And in some examples, the modular parts of these structural elements can securely house one or more filtration elements, e.g., by creating a sufficiently tight seal that holds the filtration element in place (e.g., using one or more coupling devices). In some examples, coupling devices may include a lock, an interlocking mechanism, an adhesive, a quasi-adhesive, another interlocking device, etc.

In some examples, the structural elements of the reusable elastomeric APR may securely house the filtration element (e.g., a filter) such that there may be a reduced demand on the filter, thereby allowing the reusable elastomeric APR to employ a less expensive or modular filter. Since the modular facial respirator described herein includes a modular filter holding component, the modular facial respirator can accommodate and seal filters of varying dimension and thickness. Further, the modular facial respirator may include filter retention mechanism.

In this example, the filter retention mechanism includes a ratcheting ramp feature that enables an effective seal to be formed by providing pressure between the sealing element of the grill and filter adapter components. In some examples, the ratcheting ramp feature of the filter retention mechanism may include an interlocking bayonet type. Further, this filter retention mechanism may provide an effective seal, while also retaining filters of various thickness and composition. In some examples, the filter retention mechanism can enable filtering media of varying capabilities or characteristics to be used (e.g., a N80, N95, organic vapor, acid vapor, oils, other filtering capabilities, etc., or a combination of these).

In some examples, the filter media itself may include additional capability in addition to capturing or blocking particles, it may include filtration of vapor and gas that may or may not be of organic or synthetic nature, and, or specific to moisture retention. Filter media may be made from non-woven polymer materials and, or may be further composed of other components such as for example but not limited to activated carbon, chemically doped activated carbon, or desiccant materials such as silica gel or other materials that offer similar moisture adsorption or absorption properties. The filter media may be a single composite element or multiple elements layered into the filter housing cartridge. For example, a particulate filter may include multiple layers of electret potential holding spunbond, and meltblown non-woven polymers, or it may also include additional specialty laminations or layers. The specialty laminations may include activated carbon, or other vapor or gas adsorbing or absorbing elements. A further example may include a filter layer composed of silica gel and cellulose paper or other desiccant fibers, or the filter element may include a pocket that holds desiccant pellets or other forms of moisture adsorbing or absorbing materials. A further example might include a multiple of one or more separate filter media layers each of varying or differing levels of protection, or capability. For example, one filter layer may be a common non-woven polymer laminate for particulate filtration, a second filter may be composed of activated carbon, and for example a separate third layer of filter media could provide specific chemical protection or moisture adsorption. Alternatively, packets of adsorbing materials may be securely placed in the

Comfort and fit are satisfied by the modular replacement of the soft elastomeric facepiece element with not limited to, but for example, extra-extra-small, extra-small, small, medium, large, wide-short and narrow-tall geometries based on NIOSH or other standard face shapes. The modularity of the design means any one or more of the components can be swapped out for replacement parts or upgraded for additional capability or adaptability. The standardized interface between the soft elastomeric facepiece and the rigid polymeric filter adapter allows for changing of facepiece sizes while maintaining the same filter adapter. This modularity simplifies supply chain, and enables rapid modification to the design if necessary. Further, the modularity enables changing materials for each of the components based on availability in the supply chain, without requiring large scale complex multi-step injection mold tooling changes. Other modifications that can be made are changing the shape or area of the filter adapter, filter cover, facepiece, or including connections for additional devices such as drinking tubes, microphones, or other sensors.

Wireless devices and sensors may be attached to the elastomeric respirator device. Such devices and/or sensors can sense, record, or otherwise provide data for an individual user. For instance, this data may be collected by a client device, remote computing device, or uploaded to a cloud computing device. Further, these devices may include an Internet of Things (IoT) device. In some examples, the data collected can be anonymized and used to track in real time and historical trends.

Sensors such as microphones may improve communication between users. For example, an embedded microphone in the elastomeric facepiece could be used to amplify a user's voice to improve speaking intelligibility or integrate with a wireless audio system for remote communications. In one example, the wireless audio system could be or include wireless headphones. A speaker or other audio playback may be included in the elastomeric facepiece or could be communicatively coupled to the microphone, so as to playback audio signals captured by the microphone. The microphone may be capable of detecting an ambient noise level, speech, or a voice of the user. Further, the microphone can enable the collection and transmission of an audio signal. The microphone may be an analog, digital, or any other suitable type of microphone. In some examples, additional sensors and/or biosensors may be used to monitor users' condition (temperature, breathing pressure, breathing frequency, etc.), safety compliance (monitor humidity, oxygen/CO2 levels, motion from wearing the elastomeric respirator device), or environmental conditions such as air quality, or aerosolized virus particulates. In some examples, additional sensors are not required but instead the filter media can be removed and sampled to identify contact with chemical or virus particles.

In some examples, safety compliance may include, e.g., a 1-way or 3-way check valve, free inhale, free exhale, bidirectional filtration. Further, in some examples, compliance may involve one or more additional sensor (e.g., a sensor for monitoring active use). In additional or alternative embodiments, an addition of a desiccate may be included in the elastomeric respirator, e.g., a desiccate such as active carbon may be included to dehumidify the air. In some examples, a client device or a remote computing device may receive the sensor signal. Further, the sensor signal may include sensor data that allows for monitoring of one or more environment conditions such as viral load monitoring internal and external sampler disc. The real-time measurement of these data can help in large-scale monitoring and tracing of virus infection status and mobility or other environmental conditions.

The elastomeric respirator device has been designed to provide maximum durability and lifetime under all U.S. Center for Disease Control (CDC) disinfection/sterilization protocols, to be lightweight, to fit within a face shield, to provide audible clarity, and to allow easy mass manufacturing through simple open-close injection molding techniques. More sophisticated fabrication features may also be considered such as multi-action injection molds, die-cutting, laser, CNC fabrication, etc. Cost models predict superior cost benefits after one or a multiplicity of uses compared to traditional reusable industrial or disposable respirators, depending on pre/during-pandemic pricing of the consumables.

In one example, the components of the elastomeric respirator device may include a soft elastomeric facepiece that is mechanically coupled to a rigid filter-adapter by way of a rotating interlock ring, and a filter grill that sandwiches and seals a filter media against the filter-adapter. The interlock ring may rotate ramped features to produce a compression seal between the facepiece and filter adapter. Straps may attach to the filter-adapter, facepiece, or intermediary component, and support the elastomeric respirator device on the head. These straps may be singular, or a multiplicity of straps. In some examples, there may be two, three, four or more straps attached to the adapter. For instance, the four straps may include two upper straps that are attached to a head-band or saddle and that secures the elastomeric respirator device to the head. Alternate configurations may include one or two straps with adjustable tension features, or three harness straps such that one saddles over the back of the head while two fit through tension adjusting clasps and wrap around the neck. Further, in some examples, a head-band can be adjusted in size. The straps may be attached by passing through features on the elastomeric respirator device that fold the strap in such a way as to enable adjustment. Lower straps may be attached to a neck-clasp. And in some examples, the neck clasp may include two or more components that are couplable together. These clasps may in some examples may allow for a strap to be fed through simply and then locked into position by passing through a rigid holding feature in the clasp that may be engaged with and disengaged without the use of tools. In alternate examples the straps may be elastic polymer or an elastic fabric blend to provide tension to hold the facepiece against the face of a wearer such that adequate seal is created between the face and mask.

In one example, the straps made of elastic material may have internal portions of material removed to further modify the elasticity or stiffness of the strap. The removal of internal material provides a means to further adjust the stiffness of the strap while maintaining redundancy in the structure such that a failure of one element is not catastrophic to the overall integrity of the seal on the face of the wearer.

In certain aspects, there may be a single strap or a multiplicity of straps that stretch over the head and or neck and that do not use an additional head-band but instead simply support the elastomeric respirator device on the head directly. Those straps may be separate components attached to a facepiece portion of the elastomeric respirator device, or they may be molded directly into the elastomeric respirator device components, or be separate modular elements that may be attached to the filter housing, or an intermediary component. In some examples, straps may attach to the filter adapter by way of stretching over extended portions of the rigid adapter. Other means may be used to attach the strap. Further, the elastomeric respirator device may include straps as components that are attached to, molded directly into, or is otherwise coupled to the facepiece itself.

The facepiece may be made of pliable elastomeric material, silicone, polyurethane, other thermoplastic materials or even other pliable resilient materials. The shape of the facepiece includes features to orient with respect to the filter adapter and to seal onto the filter adapter. The shape may also retain features that provide localized thickness and thus stiffness control. For example, ridges may pass along the sides of the nose to provide additional stiffness and compressing force to provide seal between facepiece and sides of the nose. Likewise, dissimilar materials may be bonded to the facepiece in order to deform and retain shape. For example, thin metal strip or wire may be bonded or embedded mechanically to enable user adjustment such as around the nose bridge region. The shape of the interfacing portion between facepiece and face has a geometry with slight outward curvature. This curvature is to allow the mask to seal to the face by rolling back and making greater contact with the soft skin of the person wearing the device.

The interlock feature that affixes the facepiece between the interlock ring and the filter adapter enables exchanging facepieces such as those of different sizes: small, medium, large, wide-short, narrow-tall, or others. The interlock feature is a ramped bayonet feature. In some examples, the elastomeric respirator device may include three ramped tabs on the interlock ring that mate with three tabs on the filter-adapter. Any one or multiplicity of ramped tabs may be used for this feature.

In some examples, the interlock may be placed concentrically with the port in the filter adapter and then locked (e.g., utilizing a substantially clockwise rotation, but other locking movements are also feasible), such that interlock and adapter are tightened against one another. The full assembly includes the interlock passing through the port of the facepiece such that when tightened it clamps the facepiece securely to the filter adapter. There is a rolled feature to help secure the facepiece in place creating a secure seal with similar compression to an O-ring. An O-ring or other gasket could also be used.

In additional or alternative embodiments, a sealing ring may not be required. In one example, the ramped bayonet feature includes ratcheting geometry such that opposing ramped bayonet features experience additional frictional and compressive resistance when sliding against each other. This provides secured feedback to the assembly process and prevents untwisting of the device. This ratcheting geometry is composed of, for example, a saw-tooth like feature on the ramp face of the bayonet tabs, but this ratcheting geometry could also be sinusoidal, or ridged in another manner, or applied on the cylindrical surfaces between components as a means to retain and tighten components.

An interlock mechanism may affix the filter grill to the filter adapter and holding the filter media in place. For instance, the interlocking mechanism may be similar to the mechanism employed in the interlock ring of the facepiece. One or more ramped tabs enable closing the gap between filter adapter and grill, which secures a filter in place. The ramped tabs may for example include ratcheting ridged features to further retain the grill and adapter in secured position while providing compressive sealing force on the sealing ridge applied to a filter media. A ridge compresses the filter locally and circumferentially between the filter grill and adapter. While the ridge may include the grill, it should be appreciated that the ridge may also, or instead, include the filter adapter component.

The compression geometry may also include a ridge and a valley to further compress and create a tortuous path for airflow. Further an elastomeric O-ring or gasket could be placed or over-molded in this similar location with or as replacement to the ridge to seal the filter in place. The ramped bayonet tabs can be one or a multiplicity of tabs. In one example, the ramped bayonet tabs may include four ramped tabs. Rotating relative between filter-adapter and grill enables tightening or loosening. For instance, such a ratcheting saw-tooth-like geometry may be used to provide feedback to the user and/or to retain the grill in position. However, it should be appreciated that any suitable number, size, thickness, amount, or other measure of filter media may be used with the elastomeric respirator device.

In some examples, a shape of the filter adapter and grill are may be substantially circular. Further, in some examples, the shape of the filter adapter and grill are may be substantially planar or rectilinear. In one example, the shape of the filter adapter and grill are may be substantially circular and planar. However, it should be appreciated that the shape of the filter adapter and grill may be any suitable shape and/or geometry. For instance, rectilinear shapes are for example feasible according to certain aspects. Certain figures disclosed herein show rectilinear shaped filter adapters and/or grills.

Additionally, in another example a bent, swept-back, or curved geometry may be used for the filter housing or filter adapter. Advantageously, a bent or curved geometry may allow the filter to bend and contour in such a manner that more closely approximates a shape of a wearer's face or to more easily fit within a face shield. For instance, bent or curved geometry may enable an amount of bending and/or flexure toward a face of a wearer. The modular design of the elastomeric respirator device enables alternative configurations of elastomeric respirator device that can be changed and swapped out at different times.

The filter adapter and filter grill components provide adjustable and variable clamping as well as edge sealing of filter media. In one example, the filter grill has smooth filter facing ridge ring features that allow for (rotational) clamping with minimal friction or damage to filter media. For example, the ridge circumscribes the inner perimeter of the filter media, providing a seal such that all air inhaled or exhaled passes through filter, where the seal makes it such that breathed air is unable to bypass the filter. Additional ridge features may also provide loading support of the filter media against deformation under inhalation or exhalation pressure. In some examples the filter grill may have rib patterns that protect the filter media by supporting it during inhale and exhale, and may also prevent ingress of fingers or other object that may damage the filter. The filter adapter has ribs to provide loading support of the filter against inhalation pressure. In some examples, the ribs of a filter adapter may be radially and circumferentially aligned but they could be in other arrangements.

The filter adapter may include a filter seat that is asymmetrically aligned with the port to the elastomeric respirator device and locking ring features such that the line of sight is maintained for the user. In some examples the port of the elastomeric facepiece may not align directly outward from the mouth, but may point downward to orient the filter adapter out of the line of sight of the wearer. An arrow and/or alignment keyway or one or more index features on the elastomeric respirator device and filter adapter indicate the correct alignment of the filter adapter to the elastomeric respirator device component. The radial ribs and asymmetrically located cone baffle feature within the filter adapter direct air flow through the adapter more uniformly by distributing pressure and airflow across the filter media more evenly. In some examples the filter adapter may include one or more finger grip features. In some examples the filter grill may include one or more finger grip features.

In one example, the materials used in this device are chosen for biocompatibility, reuse and sterilization. The rigid components may be a polypropylene or copolymer polypropylene. However alternative materials of similar performance may also be used. The facepiece is composed of silicone rubber or thermoplastic elastomeric materials, or could be another soft pliable material. The filter material for particulate filtration and blockage are non-woven polymers, though other materials such as activated carbon, paper, cellulosic materials or other may also be used. Materials of similar properties can be alternatively used for each of these components.

Examples of Modular Reusable Elastomeric Respirators

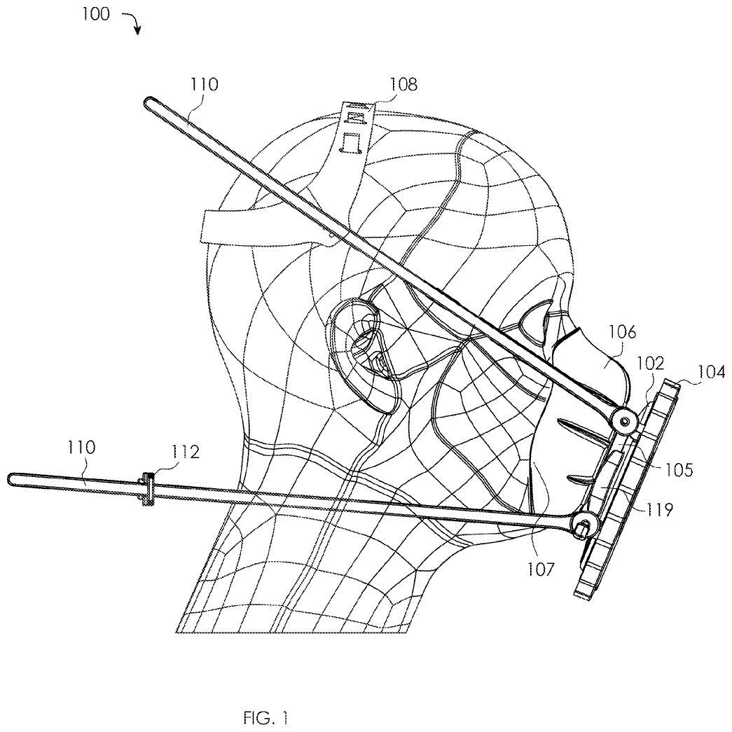

Referring now to the drawings, FIG. 1 depicts a side view of an example of a modular reusable elastomeric half-face respirator 100, according to certain aspects of this disclosure. In this example, the modular reusable elastomeric half-face respirator includes a reusable elastomeric APR in accordance with the invention. Further, the modular reusable elastomeric half-face respirator is illustrated on a person wearing the respirator in a substantially side view identifying visible components of the reusable elastomeric APR, according to certain aspects of this disclosure.

For instance, the example shows a filter adapter 102 coupled to a filter grill assembly 104, which may be used to enclose or encapsulate filter media. In this example, the filter adapter 102 and filter grill assembly 104 are coupled to an elastomeric facepiece 106. Further, the elastomeric facepiece 106 may include a secure fitment for a wearer that is provided by a combination of an adjustable headband 108, head harness of multiple straps 110, and a neck strap clip assembly 112. The straps 110 affix to filter adapter, e.g., filter housing, 102 by way of lugs, however, in this and in some other examples the strap may not be drawn fully affixed to the filter adapter 102. Finger grips 119 are features of filter adapter 102. The elastomeric facepiece 106 includes an interfacing portion 107 that is configured to seal to the face of the person wearing the respirator device. As further described herein, the interfacing portion 107 can have a geometry with an outward curvature, the outward curvature allowing the interfacing portion to seal to the face of the person wearing the device by rolling back to improve sealing edge stiffness, and increasing contact area between the facepiece and the face. The facepiece further includes a port 105, which in this example is a single port of the facepiece and is configured to couple to the filter adapter 102.

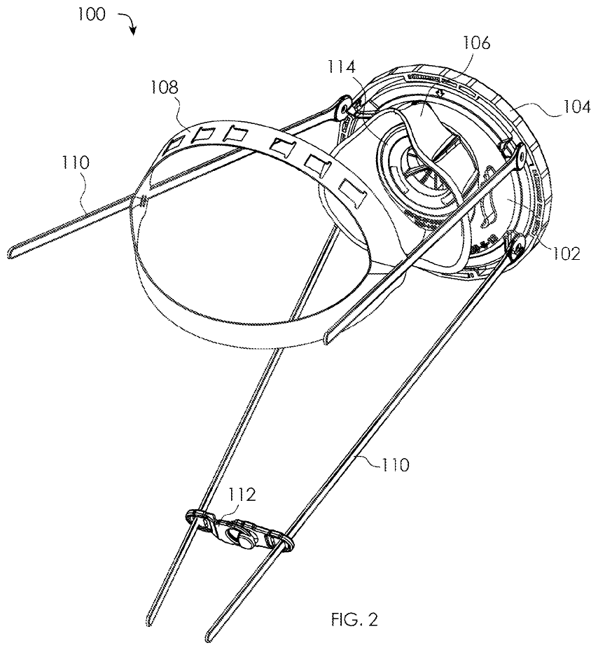

FIG. 2 depicts a perspective view of modular reusable elastomeric half-face respirator 100, according to certain aspects of this disclosure. The example shows a perspective view of a filter adapter 102 and filter grill assembly 104, which are coupled to elastomeric facepiece 106 by way of a lock ring 114. The lock ring 114 extends, at least partially, through port 105 of the facepiece. Further, the elastomeric facepiece 106 may include a secure fitment for a wearer that is provided by a combination of an adjustable headband 108, head harness assembly 110, and a neck strap clip assembly 112.

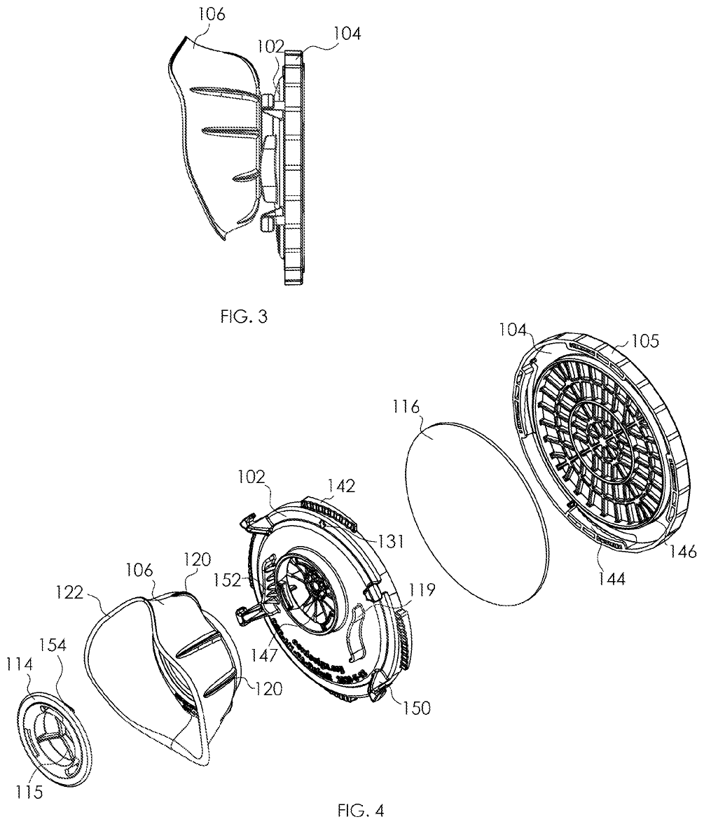

FIG. 3 depicts a side view of modular reusable elastomeric half-face respirator 100, according to certain aspects of this disclosure. The figure illustrates the elastomeric facepiece 106, the filter adapter 102, and the filter grill assembly 104 of the APR, according to certain aspects of this disclosure. The side view shows the coupling of the filter adapter 102, filter grill assembly 104, and elastomeric facepiece 106. In this figure, the respirator device is shown without headband 108, head harness assembly 110, and neck strap clip assembly 112.

FIG. 4 depicts an exploded view of the modular reusable elastomeric half-face respirator 100 of FIG. 3, according to certain aspects of this disclosure. The figure shows an exploded view that includes lock ring 114 that securely couples elastomeric facepiece 106 to filter adapter 102, which is also coupled to filter grill assembly 104. In this example, the exploded view shows a filter media component 116 that can be enclosed or encapsulated by the coupling of the modular filter adapter 102 and filter grill assembly 104. In FIG. 4, the respirator device is shown without headband 108, head harness assembly 110, and neck strap clip assembly 112. Shown are lugs 150 to which the head harness assembly 110 can be coupled.

The lock ring 114 and the representative filter media component 116 can provide the modular reusable elastomeric half-face respirator with a flexible structure, according to certain aspects of this disclosure. For instance, since the lock ring 114 may provide a substantially tight seal for the facepiece 106 components between itself and the filter adapter 102, and similarly the grill assembly 104 may provide a substantially tight seal for the filter media 116 between the filter grill 104 and filter housing or adapter 102, the modular reusable elastomeric half-face respirator can effectively prevent particulates from entering the elastomeric respirator device at connection points along its housing. One or more bayonet interlocking complimentary retention features 154 on the lock ring 114 and matching features 152 on the port of the filter adapter 102 provide holding force to seal the facepiece 106 secure and sealed to the filter adapter 102.

As illustrated in FIG. 4, the lock ring 114 can include one or more radially oriented handles, shown here as three spokes 115, which allow a user to easily grip the lock ring, orient the lock ring relative to the facepiece, place the lock ring in the port, and rotate the lock ring, e.g., during assembly or disassembly of the modular respirator device. The spokes 115 can be aligned with the retention features 154, e.g., there can be one spoke 115 for each retention feature 154. As further described herein, each retention feature can be a bayonet tab that includes a ratcheting ramp face. And because the lock ring 114 is modular and removable, an overall effectiveness of changing facepieces of varying size and shape can expand capability and fit for different wearers of the device. The modularity this aspect of simple and secure replaceable attachment of multiple facepieces provides better fit as well as maintenance, repair, and supply chain resiliency. Similar retention methods are shown in this example as one or more ratcheted ramp bayonet features 142 on filter adapter 102 and their mating complementary features 144 on filter grill 104. This modularity afforded by the adjustable compression height of the bayonet features provides an overall effectiveness of the representative filter media 116, which may be improved by increasing accessibility for changing, cleaning, replacing with different functionality, or combining multiple filter media 116 to make varying combinations of capability of filter media. In some cases, this cartridge assembly may allow composite filter structures that make use of modified or customized filter grill 104 components that maintain their own complimentary bayonet features 144 to interface to the bayonet features retention bayonet features 142 thus further expanding modular capability of the APR.

As illustrated in FIG. 4, the filter adapter 102 can include an alignment feature 131 to indicate correct alignment of the filter adapter to the facepiece 106. The facepiece 106 can include an indexing feature to orient the facepiece with respect to the filter adapter 102. The facepiece 106 can include ribs or ridges 120, which are features that provide localized thickness to control stiffness of the facepiece, as further described herein. When present, one of the ridges 120, e.g. the ridge 120 shown near the upper portion of the facepiece 106, can function as an indexing feature. Also illustrated in FIG. 4 are finger grips 119 and ribs 147 of the filter adapter 102 and finger grips 105 and ridged ring feature 146 of the filter grill 104.

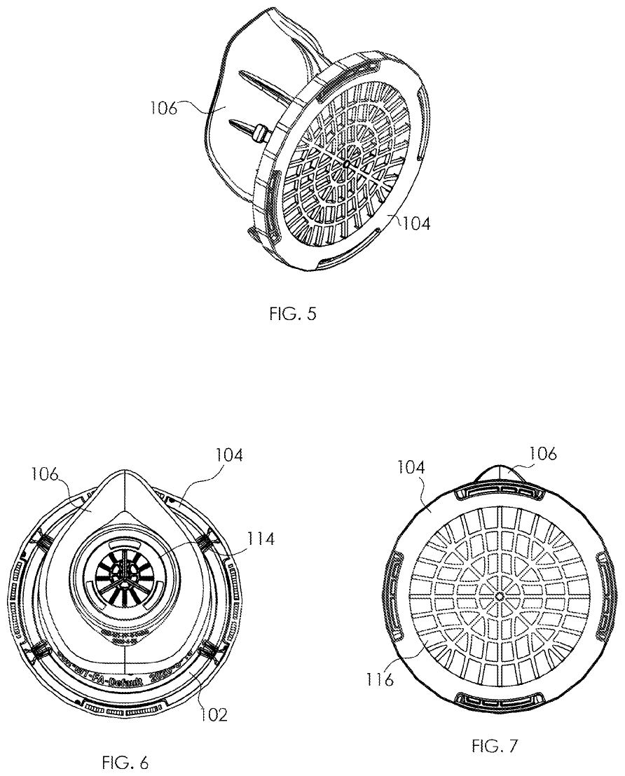

FIG. 5 depicts a perspective view of the modular reusable elastomeric half-face respirator of FIG. 3, according to certain aspects of this disclosure. In this example, the modular reusable elastomeric half-face respirator includes filter grill assembly 104 coupled to filter adapter 102 (mostly hidden from view) and elastomeric facepiece 106. Further, when coupled together, the filter grill assembly 104, filter adapter 102, and elastomeric facepiece 106 create a housing that retains a representative filter media component 116 (FIG. 4).

FIG. 6 depicts a rear view of the modular reusable elastomeric half-face respirator of FIG. 3, according to certain aspects of this disclosure. The example shows a rear view that includes filter adapter 102 coupled to filter grill assembly 104, which may be used to enclose or encapsulate filter media. In this example, the filter adapter 102 and filter grill assembly 104 are coupled to elastomeric facepiece 106 by way of lock ring 114. Further, the elastomeric facepiece 106 may include a secure fitment for a wearer while being securely coupled to the filter adapter 102 and filter grill assembly 104 by the lock ring 114. For instance, lock ring 114 may be engaged with the filter adapter 102 in such a manner to create a seal with the elastomeric facepiece 106 that completes a filtered air pathway.

FIG. 7 depicts a front view of the modular reusable elastomeric half-face respirator of FIG. 3, according to certain aspects of this disclosure. The example shows a front view that includes filter adapter 102 (mostly hidden from view) that is coupled to filter grill assembly 104, which form an enclosure around filter media 116. And in this example, the filter adapter and filter grill assembly 104 are coupled to elastomeric facepiece 106. Portions of each of the four ratcheting ramp features 142 (FIG. 4) of filter adapter 102 are visible through four openings in the filter grill 104.

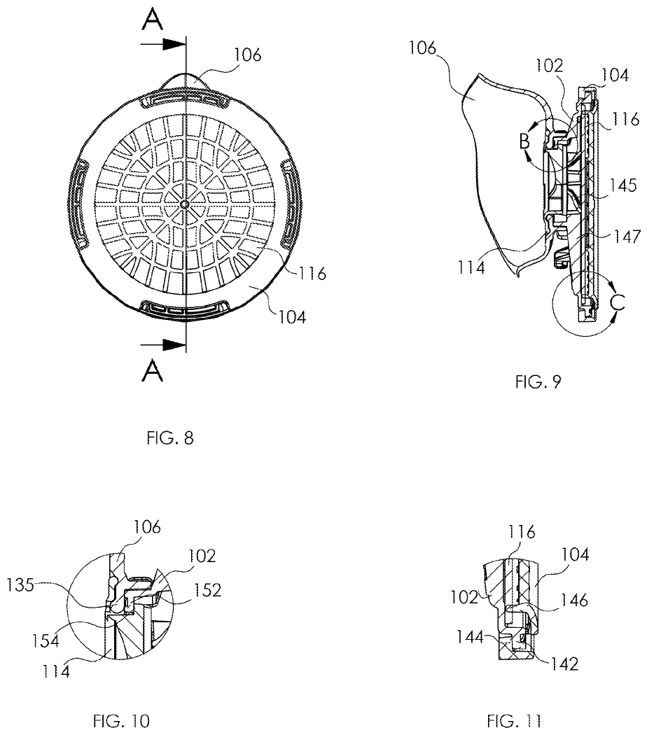

FIG. 8 depicts another front view of the modular reusable elastomeric half-face respirator, according to certain aspects of this disclosure. In this example, FIG. 8 shows the bifurcating line between points A-A that is described as a cross-sectional view between points A-A with regard to FIGS. 9-11 below.

FIG. 9 depicts a cross-sectional view of a modular reusable elastomeric half-face respirator, according to certain aspects of this disclosure. In this example, the modular reusable elastomeric half-face respirator is shown in a side view of the bifurcated cross-section A-A of FIG. 8. In this example, the elastomeric respirator device includes filter adapter 102 coupled to elastomeric facepiece 106, which is further described below as a seal (e.g., in Detail B), with regard to FIG. 10. Further, the elastomeric respirator device includes filter grill 104 coupled to filter adapter 102. In this example, filter grill 104 coupled to filter adapter 102 is further described below as a mechanical engagement (e.g., in Detail C), with regard to FIG. 11. Also shown in this view are features of filter adapter 102 that can be described as baffles 147 included to afford a displacement of exhaled air such that air velocity does not jet directly through the center of the filter media, but is more evenly distributed across the filter media component 116. Also visible is the breathing port that seals the filter adapter 102 to the facepiece 106 by way of lock ring 114. As can be seen, the lock ring 114 is located off-center from the filter grill 104. This asymmetric arrangement in this example is to reduce visual impact of the filter grill assembly for the wearer.

FIG. 10 depicts an example of a compression seal for a modular reusable elastomeric half-face respirator, according to certain aspects of this disclosure. In this example, the portion of the elastomeric respirator device shown in FIG. 10 is Detail B, mentioned above with regard to FIG. 9. The detail view includes filter adapter 102 coupled to elastomeric facepiece 106, which is sealed by lock ring 114 engaging on complimenting bayonet features 154 and 152 of lock ring 114 and filter adapter 102, respectively. The seal is generated by compressing facepiece overhanging feature 135 between the rigid components 114 and 102. The overhang feature 135 of facepiece 106 includes an integrated O-ring. Further, in this example, a compression seal is shown that includes a geometric fit that is formed between the lock ring 114, filter adapter 102, and elastomeric facepiece 106, e.g., when these components are assembled.

FIG. 11 depicts a detail of a filter grill for a modular reusable elastomeric half-face respirator, according to certain aspects of this disclosure. In this view, the portion of the elastomeric respirator device shown in FIG. 10 is Detail C, mentioned above with regard to FIG. 9. The example includes filter adapter 102 coupled to filter grill assembly 104, which encloses and/or retains filter media component 116, e.g., when these components are assembled. In this example, ridge 146 of filter grill 104 compresses filter media component 116 locally and circumferentially between the filter grill and adapter 102. The compressing force is provided here shown by interlocking tab features 144 on the filter grill 104 and retention feature 142 of filter adapter 102.

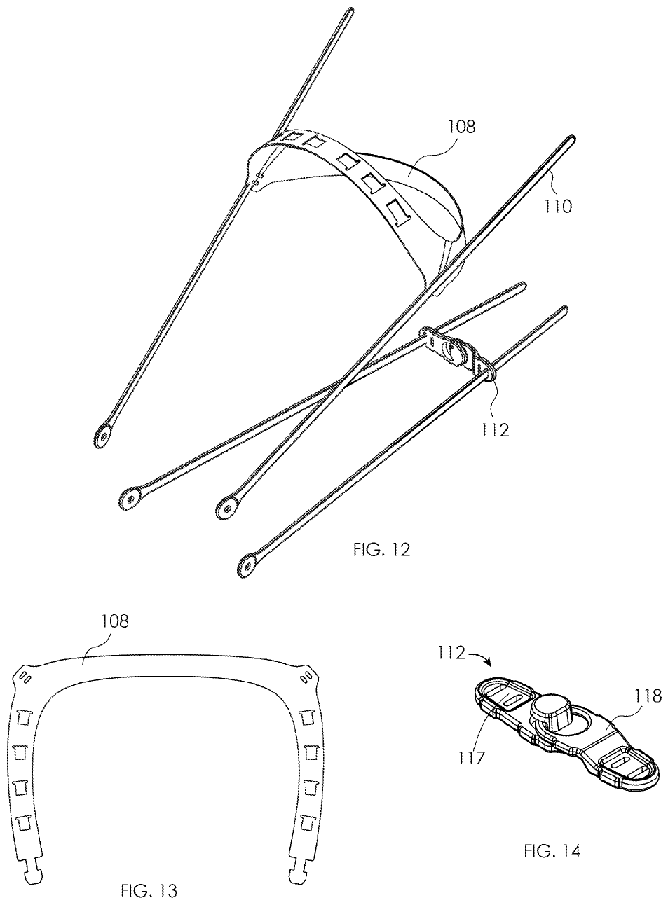

FIG. 12 depicts a perspective view of an example of a head harness assembly for a modular reusable elastomeric half-face respirator, according to certain aspects of this disclosure. In this example, the head harness assembly includes adjustable headband 108, head harness strap assembly 110, and neck strap clip assembly 112. In some examples, the head harness strap assembly 110 may include one or more elastic straps.

FIG. 13 depicts a top view of an example of an adjustable headband 108 for a modular reusable elastomeric half-face respirator, according to certain aspects of this disclosure. In some examples, the adjustable headband 108 may be a single component that includes one or more elastic strap, adjustments, or other flexible features.

FIG. 14 depicts a perspective view of an example of a neck strap clip assembly 112 for a modular reusable elastomeric half-face respirator, according to certain aspects of this disclosure. In this example, the neck strap clip assembly 112 includes a hook component 117 and a loop component 118. Further, the neck strap clip assembly 112 may be a single component that includes one or more elastic strap, adjustments, or other flexible features.

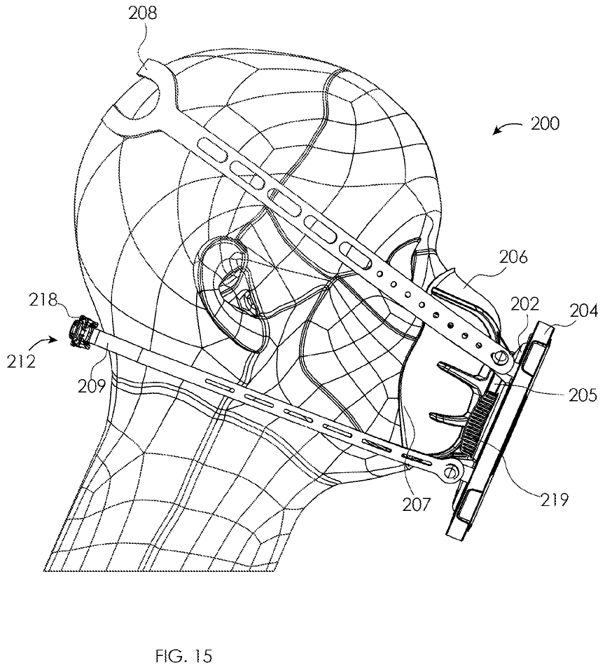

Referring now to the drawings, FIG. 15 depicts a side view of another example of a modular reusable elastomeric half-face respirator device 200, similar to that depicted in FIGS. 1-14, with some small modification, according to certain aspects of this disclosure. In this example, the modular reusable elastomeric half-face respirator includes a reusable elastomeric APR in accordance with the invention. Further, the modular reusable elastomeric half-face respirator is shown in a substantially side view as worn by a user, according to certain aspects of this disclosure.

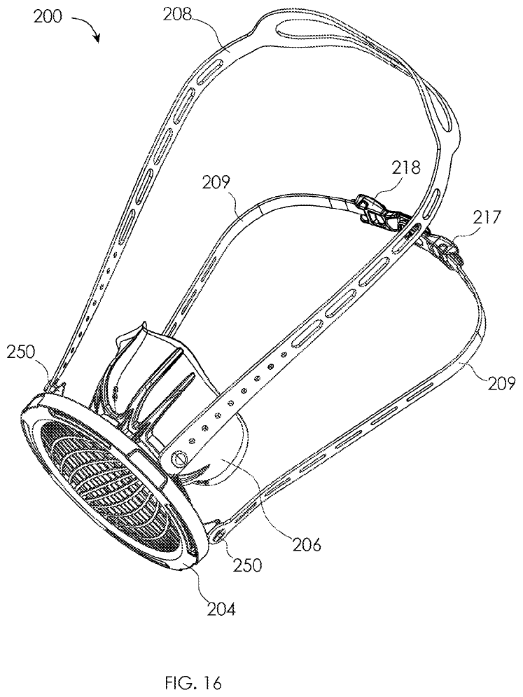

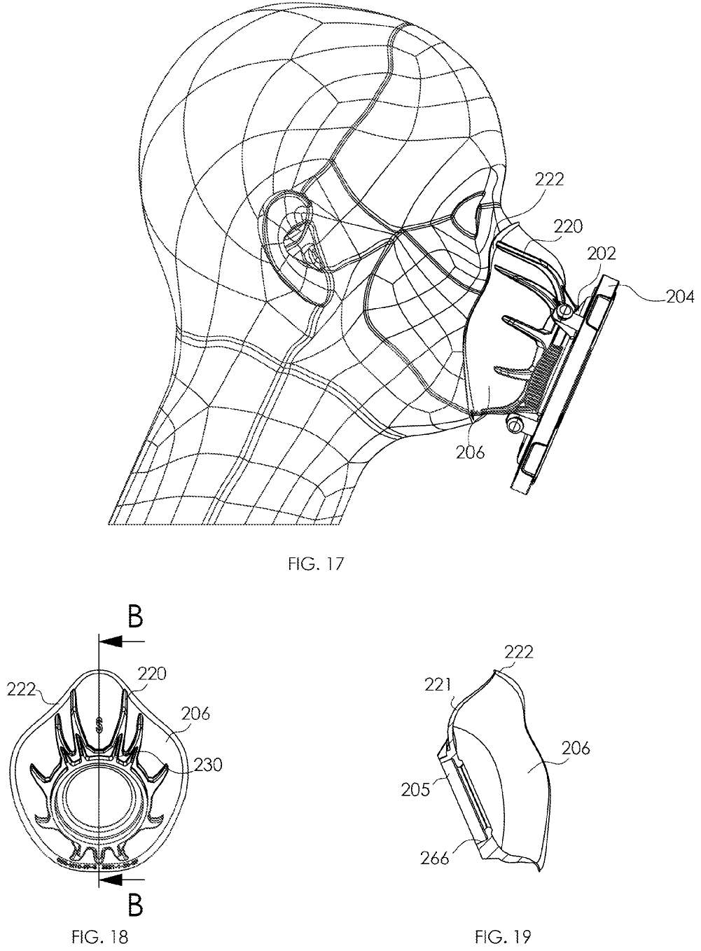

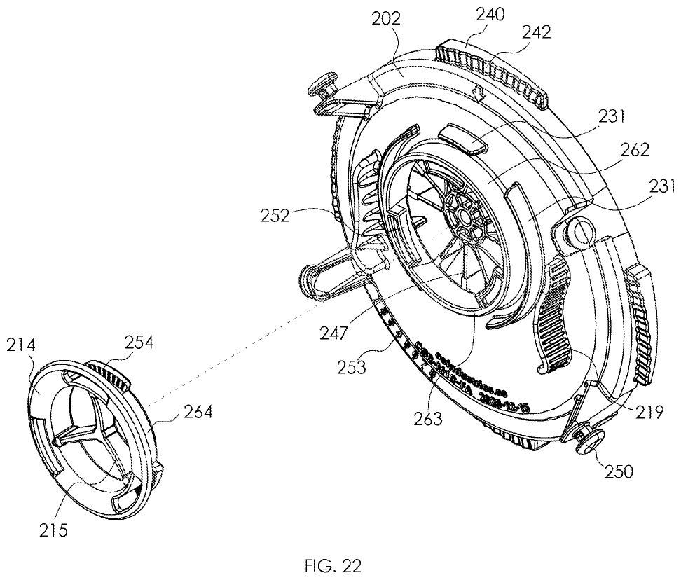

For instance, the example in FIG. 15 shows a filter adapter 202 coupled to a filter grill assembly 204, which may be used to enclose or encapsulate filter media. In this example, the filter adapter 202 and filter grill assembly 204 are coupled to an elastomeric facepiece 206. Further, the elastomeric facepiece 206 may include a secure fitment for a wearer that is provided by a combination of an adjustable head harness components that may include a top head strap 208, neck strap 209, and clip assembly 212, including clasps 217 and 218 (see also FIG. 16), attached to filter adapter 202 by way of attachment lugs 250. The adapter 202 is itself in contact with the facepiece 206 that includes a port 205 to couple to the adapter. The facepiece 206 includes an interfacing portion 207 configured to seal to the face of the user. Element 219 on filter adapter 202 is an exemplary embodiment of a gripping feature for the respirator such that the respirator may be held in one hand and the grill 204 may be tightened or loosened in retaining of the grill. Similarly, the finger grips 219 may be used to hold the filter adapter 202 securely while tightening or loosening lock ring 214 (FIG. 22) when affixing facepiece 206 to filter adapter 202.

FIG. 16 depicts a perspective view of a modular reusable elastomeric half-face respirator, according to certain aspects of this disclosure. In this example, the modular reusable elastomeric half-face respirator includes a perspective view identifying all assembly components, according to certain aspects of this disclosure. The example shows a perspective view of a filter adapter 202 and filter grill assembly 204, which are coupled to an elastomeric facepiece 206. The grill 204 in this example is shown with a differing grill pattern than that shown in FIGS. 4, 5, and 8, illustrating the modular ability to use different component designs interchangeably with this exemplary APR. Further, the elastomeric facepiece 206 may include a secure fitment for a wearer that is provided by a combination of an adjustable overhead headband 208, and a neck strap clip assembly composed of identical straps 209 and mating clasps 217 and 218. The tension capability of the strap harness may be tuned by the material of the strap and or the cross section removed from the strap, shown as slots on head harness straps 208, and 209. In this example the straps attach to filter adapter 202 by way of protruding lugs 250. The shape of the lugs shown in this example may be any such that they may pass through or attach to a feature on the harness straps, but they may be male or female complimentary designs. These attachment points may also lie on the facepiece 206, grill 204, or an intermediary component, not shown, that may be located between the facepiece 206 and filter adapter 202 and able to apply pressure against 206 and against the face to secure fitment. Further, in the example shown neck straps 209 are shown to be reversibly connected by clasps 217 and 218, but the entire assembly may be replaced by a single strap, and that strap may be composed of elastomeric materials or other elastic, elastic-fabric, textile, leather, or any other material of a nature that may securely hold the respirator device to the head of a user.

FIG. 17 depicts an example of an APR assembly fitted to a face of a user without harness shown. Facepiece 206 is seated against the face such that the chin and nose are both covered. In this example, ridge 220 passes from the interface with filter adapter 202 towards the face. This ridge is a raised element that provides additional stiffness to apply pressure toward the difficult to apply pressure and seal space along the more vertical or steep oriented portion of the nose of the user. This ridge 220 helps translate the nominal securing force from the straps (FIG. 15) into sealing pressure along the nose. Similarly, ridges at other locations around the facepiece 206 may provide additional stiffness adjustments to provide fit and comfort. In this example, the ridges 220 are formed directly into the facepiece 206 during manufacturing but in other embodiments these may be one or more external components shaped to apply directed stiffness or force, to improve comfort and seal. Similarly, in this example, facepiece 206 includes a curl 222 may be a constant radius or varying radius curvature that circumscribes the perimeter of the facepiece 206. The curl 222 provides additional structure to the perimeter of facepiece 206 such that necessary pressure may be applied to provide secure and tight-seal to the face.

In FIGS. 15 and 17, the exemplary APR assembly is shown to be fitted to the face such that there is a clear path of vision for the wearer. In this example, the port 205 (FIG. 15) of facepiece 206 is oriented pointing at an angle downward from the line of sight such that filter adapter 202 and filter grill 204 minimally obstruct the vision of the wearer. The angle of tilt may vary from each facepiece (e.g., mask) size. An additional feature shown in this example is the port 205 of the filter adapter 202 is asymmetrically located along the vertical orientation of the filter adapter to further improve vision.

The example shown in FIG. 18 continues as an additional forward looking view where facepiece 206 is of similar composition to 206. In this view the curl 222 can be seen circumferentially sweeping the perimeter of the facepiece with curl of varying degrees from none to fully reversed direction. This curl provides structure as well as extended contact surface area to provide seal against the face. Also shown in the example are indexing ridge features 230 so placed as to enforce a single orientation of the facepiece 206 with respect to the filter adapter 202, as described previously. For example, these indexing features 230, here four ridges, prevent orientation in any but one orientation and also provide root stiffness to one or more of ridges 220 that provide spatially varying stiffness to the facepiece structure. The section view B-B is shown in FIG. 19, which helps further illustrate means of varying geometric stiffness.

Further example of varying stiffness is shown in FIG. 19 the section view B-B. In this example curl 222, is shown to have varying depth, angle and thickness at different locations around the perimeter of facepiece 206. Also exemplified in this section view is the varying wall thickness illustrated by the section 221. This change in thickness is another example of spatially varying geometric modification of stiffness to provide among other features structure, comfort and secure seal and fit. The wall thickness may be constant, stepped, or any varying parameter is in this example a gradient. This feature may be additionally pronounced in the nose bridge region to reduces pressure on the nose and make clearance for eye-wear. Also illustrated is port 205 of the facepiece and inner face 266 of the cylindrical wall of the port 205.

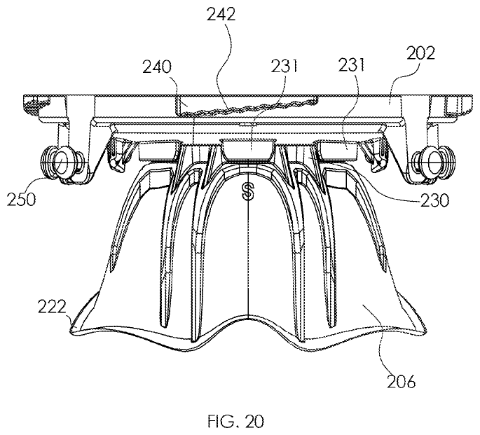

Depicted in FIG. 20 are exemplary indexing features to help orient and locate the facepiece 206 with respect to filter adapter such that there may be a specific orientation. In this example, one or more of ridge feature 230 protrude from facepiece 206 to enforce a rotational constraint against one or more feature(s) 231 on filter adapter 202. As shown, these features are ribs or ridges, but they may be of any form that performs similar behavior. In this example, a multitude of ribs 231 enforce a single readily assembled rotational configuration or orientation of facepiece 206 with respect to filter adapter 202. Other features shown, for example, in FIG. 20 include head harness mounting lugs 250, shown as a multiple of four lugs, but could be one or more in different instantiations. The attachment point shown as 250, is one example of a feature that may be used to provide modular attachment of a harness, such as straps 208, 209. The shape of these lugs may be round or otherwise. Similarly, the post these lugs are shown to sit on that protrude from filter adapter 202 may be made of a different form. The male feature 250 also similarly could be a female complementary feature instead. Modular attachment of harness straps 208, 209 as depicted in FIG. 16 and similar components are just one example of an attachment means. A mechanism to retain the filter grill onto filter adapter 202 is shown as feature 240, a ratcheted ramping bayonet feature.

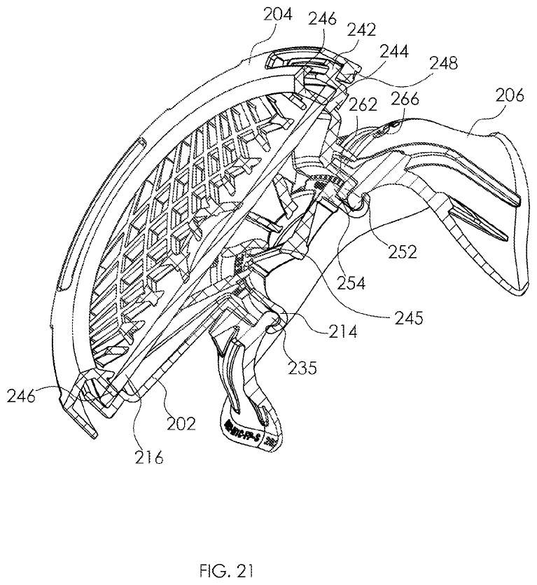

In the FIG. 21 a cut-away view of the modular respirator device is shown to further exemplify the sealing components of the device. Lock ring 214 secures the facepiece 206 to the filter adapter 202 by way of one or more ramped bayonet features. The ramp contacting surfaces are shown as features 254 and 252 for the lock ring and filter adapter, respectively. In this example rotational motion of the lock ring 214 relative to the filter adapter 202 causes the bayonet features to engage and pull axially together, creating an axial compression force on the facepiece, particularly around the integrated o-ring geometry 235. This integrated o-ring is not mandatory, but is helpful in providing seal, causing further interference and gap filling. The overhang of lock ring 214 provides circumferential sealing pressure of the facepiece against the filter adapter 202. Additional sealing is afforded by radial interference between the cylindrical face 262 of the filter adapter 202 and the cylindrical face 266 of the facepiece 206. While both sealing interfaces, the cylindrical and axial, are not required, they provide redundant sealing interference. Shown in this embodiment the bayonet features each have complementary ramped and ratcheted features, providing tightening and locking behavior. The ratchet behavior provides both audible and tactile feedback to the operator during installation. As an example of compressive seal, engagement of three clicks of the ratchet features provides one or more millimeters of displacement between the lock ring 214 and filter adapter 202, producing 80 N of axial compressive force on the facepiece 202. This axial force translates to a rotational holding torque of the lock-ring position, requiring roughly 3 Nm of torque to release. The holding torque and compression force can be adjusted by tuning the angle of the bayonet ramp and angle of the helically swept ratchet features.

An interlock mechanism may affix the filter grill to the filter adapter and holding the filter media in place. For instance, the interlocking mechanism may be similar to the mechanism employed in the interlock ring of the facepiece. One or more ramped tabs enable closing the gap between filter adapter and grill, which secures a filter in place. This similar retaining behavior may be implemented between the filter grill 204 and filter housing or adapter 202. One or more bayonet features 240 as shown in FIG. 20 and similar to that shown in FIG. 4 bayonet 142 are rotationally locked into position against complimentary bayonet features 242 and 244 in the filter grill 204. The compression ridge 246 is similar to 146 in FIG. 11, in that it provides retention and sealing of the filter media 116 or 216. In this example, the filter retention mechanism includes a ratcheting ramp feature that enables an effective seal to be formed. In some examples, the ratcheting ramp feature of the filter retention mechanism may include an interlocking bayonet type. Further, this filter retention mechanism may provide an effective seal, while also retaining filters of various thickness and composition. The assist the user in rotationally locking filter grill 204 to filter adapter 202, the filter grill, the filter adapter, or both can include finger grip features, such as finger grips 219 illustrated in FIGS. 15 and 22.

In some examples, the filter retention mechanism can enable filtering media of varying capabilities or characteristics to be used (e.g., a N80, N95, organic vapor, acid vapor, oils, other filtering capabilities, etc., or a combination of these). The axial displacement due to the bayonets produce a compressive stress on the filter media that is sandwiched or compressed between the sealing ridge 246 and the face 248 of the filter adapter. The ramped shape of the bayonet features provides the ability to compress a range of filter media thicknesses. Since the modular facial respirator described herein includes a modular filter holding component, the modular facial respirator can accommodate and seal filters of varying dimension and thickness. This allows the respirator device to be agnostic to filter media, enabling a range of filter materials or combinations of one or multitudes of filter material to be stacked together within the filter housing and grill assembly. When combined the filter housing and grill may be considered a cartridge assembly. The complementary ramp features of 242 and 244 provide audible, tactile, or visual feedback to indicate an adequate compressive sealing force is generated. In the shown embodiment three clicks correlate to 80 N of holding force and 3 Nm of rotational retention, however this force and retention torque can be adjusted based on the angle of the bayonet ramp and the depth and angle of the ratchet complimenting surfaces. Visual indication of sealing pressure may also be referenced from label features 253 on the filter housing. One or more ribs 247 emanate from along the inside of the filter adapter 202, and filter grill further support the filter media providing support for both stiff and flexible filter media. One or more internal baffles 245 help to evenly distribute air pressure and flow across the filter media.

In FIG. 22 a filter housing also referred to as filter adapter 202 is shown with lock ring 214 to further show the geometric features of each component. The lock ring has one or more bayonet features 254 that interface with complementary features 252 in filter adapter 202 upon rotational relative motion between the two components. A modular facepiece 206, not shown in FIG. 22, would otherwise be compressed between these two components, as illustrated in FIG. 21. As illustrated in FIG. 22, the lock ring 214 includes a cylindrical body 264 and the bayonet tabs 254 extend radially outward from the cylindrical body. The lock ring 214 can include one or more handles 215 to allow a user to grip and rotate the lock ring 214. As illustrated, the handles 215 are radially oriented and, in this example, in the form of three spokes. Here, the spokes are aligned with the bayonet features 254 but other arrangements are contemplated.

The modularity of the respirator device is provided by removable interlocking components, e.g. lock ring 214, and the standardized interface provided by them. Two primary surfaces on the filter adapter 202 are used to seal to the modular facepiece 206, the cylindrical radial sealing interface 262, and the axial sealing interface 263. The cylindrical interface 262 also provides translational constraint, e.g. indexing, between the facepiece 206 and filter adapter 202. An arrow and/or alignment keyway or one or more index features on the elastomeric facepiece and filter adapter indicate the correct alignment of the filter adapter to the elastomeric facepiece component. Rotational constraint of the facepiece is provided by interaction of features 231 of the adapter 202 and complementary features 230 on facepiece 206 (FIG. 20) that act as indexing features. The constraint features 231 are shown here as a series of circumferential ribs that enforce unidirectional orientation or keying of the modular elastomeric facepiece with regards to the filter housing 202.

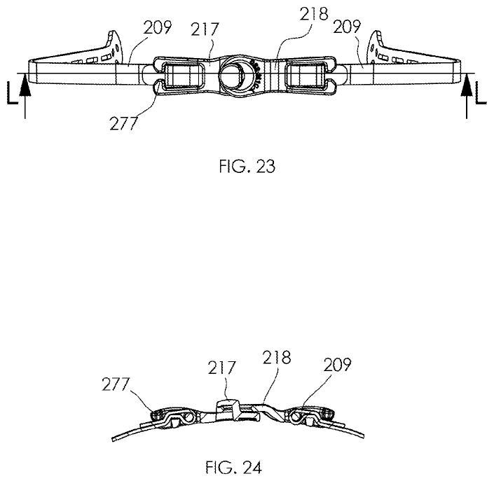

In the example shown in FIG. 23, a neck clasp assembly includes strap component 209, clasp hook 217 and clasp loop 218. This modular neck clasp assembly allows for setting the strap length and quickly attaching and detaching without changing strap length adjustment. It also, however, allows simple strap length adjustment by way of lifting the strap material through the unconnected ends of outward facing sides of the neck clasps, as shown by feature 277. This gap feature exists on both clasps 217 and 218 to allow simple loosening or tightening adjustments to the strap length.

The routing of the strap 209 through the clasp is shown in FIG. 24. In this embodiment the strap routing can be seen making a tortuous path around a first round pin and over a then trapezoidal pin, being affixed under clasping feature 277. The hook 217 and loop 218 geometry of the clasp provide means to securely locate the two clasp components together while also allowing simple separation of the components.

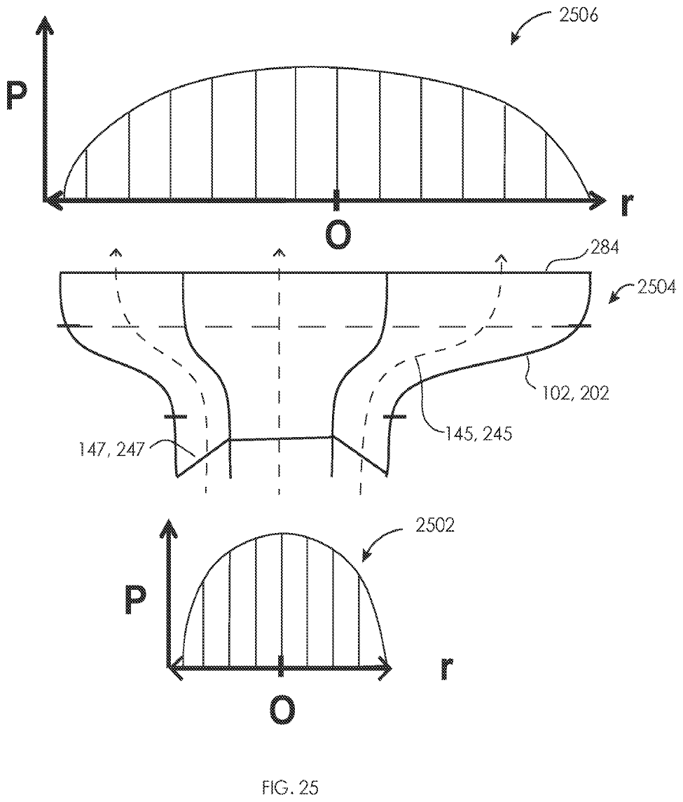

The diagram in FIG. 25 shows examples of pressure profiles 2502, 2506 of air passing through a filter adapter 2504, representative of the filter adapters 102 and 202. The increasing change in sectional area of the facepiece port, near ribs 147, 247, to the filter port at 284 shows a transition from steep pressure profile (2502) to a pressure profile with wider pressure distribution (2506). This effect of broadening the filter area and shortening and broadening the air pressure also similarly reduce the air velocity across the filter media component. By increasing the filter area, the breathed air velocity is reduced, lowering the pressure drop across the filter media component, and hence lowering the breathing resistance across the filter. Similarly, with reduced air velocity, the particle filtration efficiency of the filter media component is also improved. The middle diagram 2504 of FIG. 25 illustrates the cross-sectional area, streamlines, and baffles 145, 245 designed into the filter adapter 102 and 202. These baffles further help to spread the exhaled air to reduce the air velocity across the filter media component, improving breathing and filtration efficiency. The baffle(s) can be cone shaped and supported by at least a portion of the one or more ribs 147, 247. There can be one or more cone shaped baffles, each configured to direct air flow through the adapter to distribute pressure and airflow across the filter media component. As illustrated, the cone shaped baffle includes a wall that has a curved profile. In the pressure profiles 2502, 2506, the horizontal axis marks a centerline at the 0, and radial distance is measured as r, while P is on the vertical axis denoting pressure.

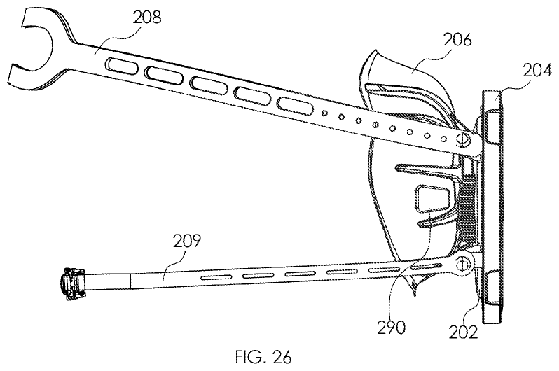

FIG. 26 depicts an example of a modular respirator device with a modular facepiece 206 including an optional port 290, e.g., an accessory port. The port 290 may represent any number of additional electronic devices or transmitting ports for exhalation valves or ports for additional capabilities such as drinking tubes or desiccant. Wireless devices and sensors may be coupled to, attached to, or otherwise integrated into the elastomeric respirator device at port 290, or directly to the filter adapter 102 or 202, or even grill 102 or 204. Such devices and/or sensors can sense, record, or otherwise provide data for an individual user. For instance, this data may be collected by a client device, remote computing device, or uploaded to a cloud computing device. Further, these devices may include an Internet of Things (IoT) device. In some examples, the data collected can be anonymized and used to track in real time and historical trends.

Sensors such as microphones may improve communication between users. For example, an embedded microphone in the elastomeric facepiece could be used to amplify a user's voice to improve speaking intelligibility or integrate with a wireless audio system for remote communications. In one example, the wireless audio system could be or include wireless headphones. A speaker or other audio playback may be included in the elastomeric facepiece or could be communicatively coupled to the microphone, so as to playback audio signals captured by the microphone. The microphone may be capable of detecting an ambient noise level, speech, or a voice of the user. Further, the microphone can enable the collection and transmission of an audio signal. The microphone may be an analog, digital, or any other suitable type of microphone. In some examples, additional sensors and/or biosensors may be used to monitor users' condition (temperature, breathing pressure, breathing frequency, etc.), safety compliance (monitor humidity, oxygen/CO2 levels, motion from wearing the elastomeric respirator device), or environmental conditions such as air quality, or aerosolized virus particulates.

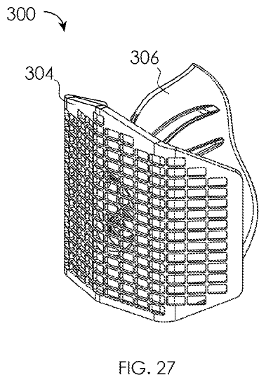

FIG. 27 depicts an example of a modular elastomeric half-face respirator 300 with a swept-back filter assembly. The facepiece 306 is of similar features as 106 and 206. In this example, the filter grill assembly 304 similarly seals to the facepiece 306 by way of a lock ring that provides compression to the grill assembly by way of mating complementary tab features such as those previously described.

Example Computing Environment for Monitoring a Respirator Device

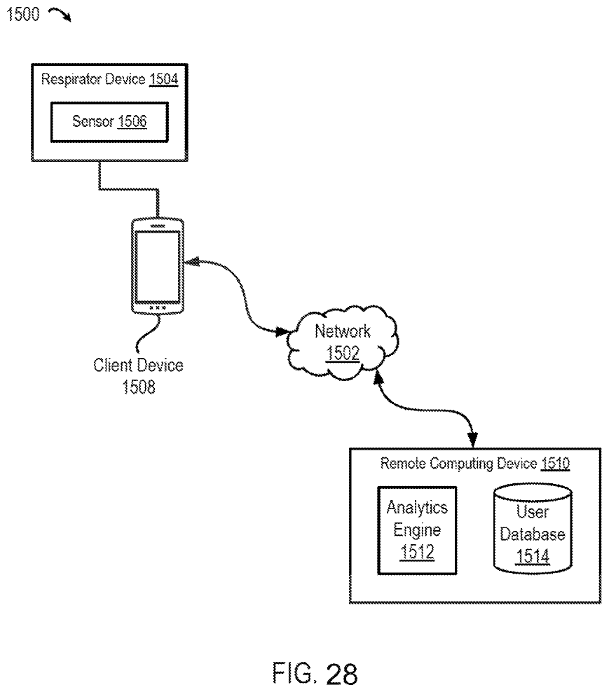

FIG. 28 depicts an example of a computing environment 1500 for monitoring a modular reusable elastomeric half-face respirator, according to certain aspects of this disclosure. In this example, the computing environment 1500 includes a respirator device 1504, which may be any of the modular reusable elastomeric half-face respirator described herein. In this example, the respirator device 1504 includes a sensor 1506 and is communicatively coupled to the client device 1508. Further, client device 1508 is in communication with a remote computing device 1510, e.g., via a data network 1502.

Examples of a client device 1508 may include, but are not limited to, a tablet, smartphone, smart watch, gaming device, IoT device, PC, server, processing unit, a combination of these devices, or any other suitable device having a processor. A user of client device 1508 may use various products, applications, or services supported by the computing environment 1500. A client device 1508 may be communicatively coupled to the sensor 1506 using any suitable wired or wireless communication technologies. Examples of wireless communication technologies include WiFi, Bluetooth, Zigbee, Near Field Communications (NFC) and Infrared.

Each of the client devices 1508 may be communicatively coupled to remote computing device 1510 via data network 1502. Examples of the data network 1502 include, but are not limited to, Internet, local area network (“LAN”), wireless area network, wired network, wide area network, and the like.

The remote computing device 1510 includes an analytics engine 1512 and a user database 1514. In some examples, the analytics engine 1512 may obtain sensor data, e.g., from client device 1508. For instance, analytics engine 1512 can analyze sensor data that includes a measurement of an ambient air quality level, presence of a type of particulate, amount of particulates, amount of aerosolized particulates, etc. Sensor data can also include additional information, such as audio data from a microphone included in the respirator device 1504.

In some examples, the remote computing device 1510 may include an IoT device. Further, the remote computing device 1510 may receive the sensor signal and/or sensor data substantially in real-time. Sensor data may also include biosensor data associated with a user of the respirator device 1504. In some examples, the remote computing device 1510 can store a user's history (e.g., biosensor data) in user database 1514. In some examples, the biosensor data may be associated with one or more user conditions such as a user's temperature, breathing rate, breathing pressure, O2 level, moisture level, movements, motion, etc.

Example Process for Monitoring a Respirator Device

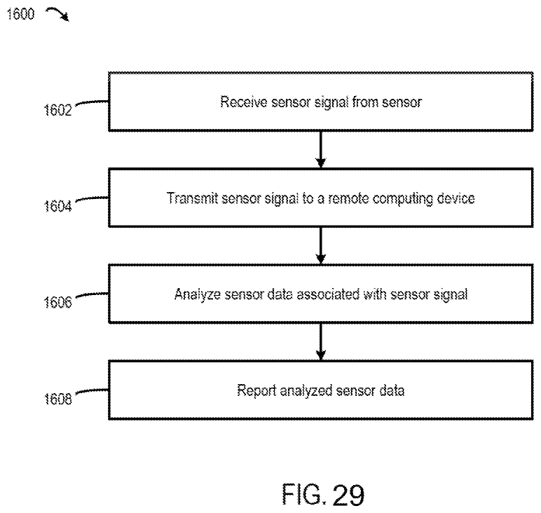

FIG. 29 depicts an example of a process 1600 for monitoring a modular reusable elastomeric half-face respirator, according to certain aspects of this disclosure.

At block 1602, the process 1600 involves receiving a sensor signal from a sensor (e.g., sensor 1506). For instance, the client device 1508 may be in electrical communication with the respirator device 1504 and/or sensor 1506. Thus, the client device 1508 can receive the sensor signal from the sensor 1506. In some examples, the sensor 1506 may include any of the sensors described herein. Further, the sensor signal may include any of the sensor data described herein. It should be appreciated that the respirator device 1504 may include one or more sensors 1506. Further, it should be appreciated that the client device 1508 may receive any number of sensor signals from the one or more sensors 1506.

At block 1604, the process 1600 involves transmitting a sensor signal to a remote computing device (e.g., remote computing device 1510). For instance, the client device 1508 can transmit the sensor signal to the remote computing device 1510, e.g., via network 1502.

At block 1606, the process 1600 involves analyzing sensor data associated with the sensor signal. For example, remote computing device 1510 can execute analytics engine 1512 to determine one or more features associated with the sensor data. In one example, the remote computing device 1510 may determine a change in an environmental condition based the sensor data. For instance, the remote computing device 1510 may determine a change in the ambient air quality based on a change in the sensor data over time (e.g., a specified or predetermined time period, length, duration, etc.). In another example, the remote computing device 1510 may determine a change in a biometric condition based on the sensor data. In some examples, the remote computing device 1510 may determine the change in the biometric condition in a substantially similar manner as the change in the environmental condition.

At block 1608, the process 1600 involves reporting the analyzed sensor data. For instance, reporting the analyzed sensor data may include generating a notification. In one example, remote computing device 1510 may generate a notification based on the change determined at block 1606. Further, the remote computing device 1510 may generate the notification for display, for example, by generating a notification that includes a warning or alert about one or more environmental or biometric conditions. In some examples, the notification may include text, audio, an image, video, or any other suitable media.

In some examples, the notification may include an alert for a dangerous environmental condition such as a high level of a type of particulate present in the sensor data. And in some examples, the notification may include an alert for a dangerous biometric condition. For instance, the notification may include an alert for a rapid breathing rate, a low O2 level, rapid heart rate, etc. Further, in some examples, the remote computing device 1510 may send the notification to the client device 1508, the respirator device 1504, another computing device, etc., or a combination of these.

Example of a Computing System for Implementing Certain Aspects

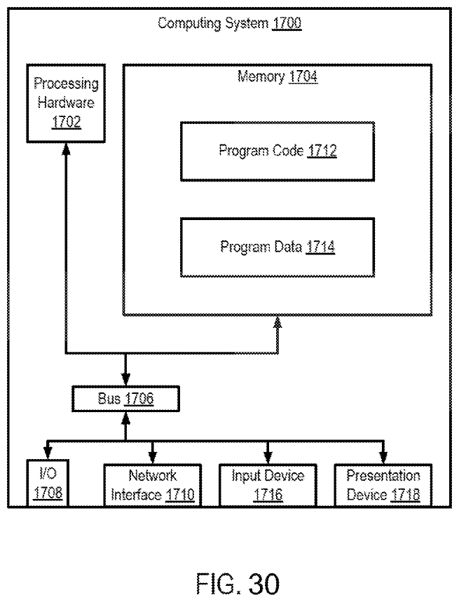

Any suitable computing system or group of computing systems can be used for performing the operations described herein. For example, FIG. 30 depicts an example of a computing system 1700. In some aspects, the computing system 1700 includes processing hardware 1702 that executes program code 1712 (e.g., the analytics engine 1512), a memory device 1704 that stores one or more sets of program data 1714 computed or used by operations in the program code 1712 (e.g., a set of data, sensor data, biosensor data, environmental data, etc.), one or more input devices 1716, and one or more presentation devices 1718 for displaying graphical content generated by executing the program code 1712. For illustrative purposes, FIG. 30 depicts a single computing system on which the program code 1712 is executed, the program data 1714 is stored, and the input devices 1716 and presentation device 1718 are present. But various applications, datasets, and devices described can be stored or included across different computing systems having devices similar to the devices depicted in FIG. 30.

The depicted example of a computing system 1700 includes processing hardware 1702 communicatively coupled to one or more memory devices 1704. The processing hardware 1702 executes computer-executable program code stored in a memory device 1704, accesses information stored in the memory device 1704, or both. Examples of the processing hardware 1702 include a microprocessor, an application-specific integrated circuit (“ASIC”), a field-programmable gate array (“FPGA”), or any other suitable processing device. The processing hardware 1702 can include any number of processing devices, including a single processing device.

The memory device 1704 includes any suitable non-transitory computer-readable medium for storing data, program code, or both. A computer-readable medium can include any electronic, optical, magnetic, or other storage device capable of providing a processor with computer-readable instructions or other program code 1712. Non-limiting examples of a computer-readable medium include a magnetic disk, a memory chip, a ROM, a RAM, an ASIC, optical storage, magnetic tape or other magnetic storage, or any other medium from which a processing device can read instructions. The program code 1712 may include processor-specific instructions generated by a compiler or an interpreter from code written in any suitable computer-programming language, including, for example, C, C++, C #, Visual Basic, Java, Python, Perl, JavaScript, and ActionScript.

The computing system 1700 may also include a number of external or internal devices, such as an input device 1716, a presentation device 1718, or other input or output devices. For example, the computing system 1700 is shown with one or more input/output (“I/O”) interfaces 1708. An I/O interface 1708 can receive input from input devices (e.g., input device 1716) or provide output to output devices (e.g., presentation device 1718). One or more buses 1706 are also included in the computing system 1700. The bus 1706 communicatively couples one or more components of a respective one of the computing system 1700.

The computing system 1700 executes program code 1712 that configures the processing hardware 1702 to perform one or more of the operations described herein. The program code 1712 includes, for example, the video editor 102, the motion estimation engine 106, the color update engine 108, or other suitable program code that performs one or more operations described herein. The program code 1712 may be resident in the memory device 1704 or any suitable computer-readable medium and may be executed by the processing hardware 1702 or any other suitable processor. The program code 1712 uses or generates program data 1714. Examples of the program data 1714 include one or more of sensor data, air quality data, user information, audio data, etc. described herein with respect to FIGS. 1-15.

In some aspects, the computing system 1700 also includes a network interface device 1710. The network interface device 1710 includes any device or group of devices suitable for establishing a wired or wireless data connection to one or more data networks. Non-limiting examples of the network interface device 1710 include an Ethernet network adapter, a modem, or the like. The computing system 1700 is able to communicate with one or more other computing devices via a data network using the network interface device 1710.

An input device 1716 can include any device or group of devices suitable for receiving visual, auditory, or other suitable input that controls or affects the operations of the processing hardware 1702. Non-limiting examples of input device 1716 include a recording device, touchscreen, mouse, keyboard, microphone, video camera, separate mobile computing device, etc. A presentation device 1718 can include any device or group of devices suitable for providing visual, auditory, or other sensory output. Non-limiting examples of the presentation device 1718 include a touchscreen, monitor, separate mobile computing device, etc.

Although FIG. 30 depicts the input device 1716 and the presentation device 1718 as being local to the computing device that executes the program code 1712, other implementations are possible. For instance, in some aspects, one or more of the input device 1716 and the presentation device 1718 can include a remote client-computing device that communicates with the computing system 1700 via the network interface device 1710 using one or more data networks described herein.

Example Exhalation Ports

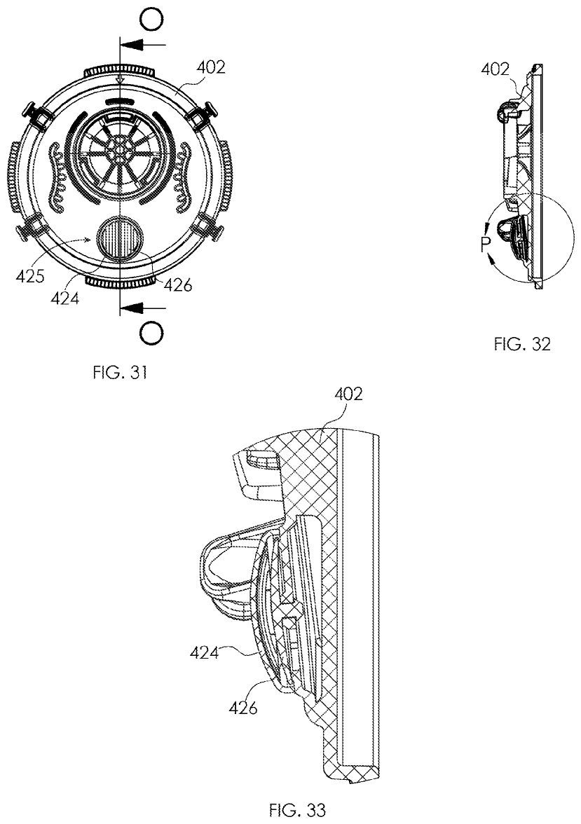

FIG. 31 depicts an example filter adapter 402, which is similar in nature to adapters 102 and 202 described above, and which includes an additional exhalation port 425, e.g., an exhaust valve. In this example, the exhalation port 425 includes an elastomeric valve 426 and a port cover 424. For safety compliance an APR may include, e.g., a 1-way or 3-way check valve, for free inhale, free exhale, or bidirectional filtration. The exhalation valve is, in this case, built into the filter adapter 402. The flexible elastomeric valve 426 is protected by the valve cover 424.

FIG. 32 depicts a section view of the filter adapter 402 shown in FIG. 31.

FIG. 33 depicts a detail view of the filter adapter of FIG. 32, showing details of the exhalation valve. In this example the valve 426 shown is a circular umbrella elastomeric (disc diaphragm) based check valve with a direct vent for exhalation. The cover or grill 424 protecting the valve is mounted to the filter adapter 402. Alternate valves such as duck bills, flaps, etc. could be employed as well. The valve can be pointed downwards, e.g., away from the wearer, with a non-grilled shield to prevent dirt build-up. Alternatively, the valve can also be integrated with or positioned on the port 290 of the facepiece as shown in FIG. 26. A sealing cover may be provided to allow the user to seal the valve 426. This sealing mechanism could be a four-bar linkage or trap door setup. Further, visual indication of the status of the valve could be integrated to show if the exhaust valve is activated or not.

### GENERAL CONSIDERATIONS

While the present subject matter has been described in detail with respect to specific aspects thereof, it will be appreciated that those skilled in the art, upon attaining an understanding of the foregoing, may readily produce alterations to, variations of, and equivalents to such aspects. Numerous specific details are set forth herein to provide a thorough understanding of the claimed subject matter. However, those skilled in the art will understand that the claimed subject matter may be practiced without these specific details. In other instances, methods, apparatuses, or systems that would be known by one of ordinary skill have not been described in detail so as not to obscure claimed subject matter. Accordingly, the present disclosure has been presented for purposes of example rather than limitation, and does not preclude the inclusion of such modifications, variations, and/or additions to the present subject matter as would be readily apparent to one of ordinary skill in the art.

Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform. The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for ease of explanation only and are not meant to be limiting.

Aspects of the methods disclosed herein may be performed in the operation of such computing devices. The system or systems discussed herein are not limited to any particular hardware architecture or configuration. A computing device can include any suitable arrangement of components that provide a result conditioned on one or more inputs. Suitable computing devices include multi-purpose microprocessor-based computer systems accessing stored software that programs or configures the computing system from a general-purpose computing apparatus to a specialized computing apparatus implementing one or more aspects of the present subject matter. Any suitable programming, scripting, or other type of language or combinations of languages may be used to implement the teachings contained herein in software to be used in programming or configuring a computing device. The order of the blocks presented in the examples above can be varied—for example, blocks can be re-ordered, combined, and/or broken into sub-blocks. Certain blocks or processes can be performed in parallel.

While example embodiments have been particularly shown and described, it will be understood by those skilled in the art that various changes in form and details may be made therein without departing from the scope of the embodiments encompassed by the appended claims.

What is claimed is:

1. A modular reusable respirator device comprising:
an elastomeric facepiece;
a filter adapter configured to couple to the facepiece;
a filter grill configured to couple to the filter adapter, the filter grill and the filter adapter cooperating to house a filter media component between the filter adapter and filter grill; and
a filter retention mechanism, the filter retention mechanism including an interlocking bayonet-type ratcheting ramp configured to provide a sealing pressure around the filter media component.

2. The respirator device of claim 1, wherein the facepiece includes an interfacing portion and a port, the interfacing portion configured to seal to the face of a person wearing the respirator device, the port configured to couple to the filter adapter.

3. The respirator device of claim 2, wherein the interfacing portion has a geometry with an outward curvature, the curvature allowing the interfacing portion to seal to the face of the person wearing the device by rolling back and increasing contact area between the facepiece and the face.

4. The respirator device of claim 2 or 3, wherein the facepiece comprises features that provide localized thickness to control stiffness of the facepiece.

5. The respirator device of claim 4, wherein the features that provide localized thickness include one or more ridges.

6. The respirator device of claim 5, wherein the one or more ridges are positioned between the port and the interfacing portion of the facepiece.

7. The respirator device of claim 6, wherein the one or more ridges generally extend away from the port and toward an edge of the interfacing portion of the facepiece.

8. The respirator device of claim 7, wherein the one or more ridges diminish in height, width, or both as the ridges extend from the port and toward the edge of the interfacing portion.

9. The respirator device of claim 5, wherein the one or more ridges are integrally formed with the facepiece.

10. The respirator device of any one of claims 2-9, wherein the port includes an integrated O-ring feature defining a circular opening.

11. The respirator device of claim 10, wherein the port further includes a cylindrical wall concentrically aligned with the circular opening.

12. The respirator device of any one of claims 2-11, wherein the facepiece includes an indexing feature to orient the facepiece with respect to the filter adapter.

13. The respirator device of claim 12, wherein the indexing feature includes one or more protrusions at or near the port.

14. The respirator device of any one of claims 1-13, further comprising a lock ring to secure the facepiece to the filter adapter via a facepiece retention mechanism.

15. The respirator device of claim 14, wherein the facepiece retention mechanism includes an interlocking bayonet-type ratcheting ramp configured to provide a sealing pressure.

16. The respirator device of claim 15, wherein the facepiece retention mechanism includes one or more pairs of opposing interlocking bayonet-type ratcheting ramps, each pair including a bayonet-type ratcheting ramp provided by the lock ring and another bayonet-type ratcheting ramp provided by the filter adapter.

17. The respirator device of claim 16, wherein the lock ring and the filter adapter each include bayonet tabs that provide the ratcheting ramps, each bayonet tab including a ramp face having a ratchet feature, optionally having a saw-tooth like, triangular, sinusoidal, or ridged geometry.

18. The respirator device of claim 17, wherein the lock ring includes a cylindrical body and the bayonet tabs of the lock ring extend radially outward from the cylindrical body, and wherein the filter adapter includes a cylindrical wall and the bayonet tabs of the filter adapter extend radially inward from the cylindrical wall.

19. The respirator device of claim 18, wherein the lock ring includes one or more spokes, optionally at least a portion of the spokes aligned with the bayonet tabs of the lock ring.

20. The respirator device of any one of claims 1-19, wherein the filter adapter includes one or more ribs to provide loading support for the filter media component against inhalation pressure.

21. The respirator device of claim 20, wherein the filter adapter includes a cone shaped baffle supported by at least a portion of the one or more ribs, the cone shaped baffle configured to direct air flow through the adapter to distribute pressure and airflow across the filter media component.

22. The respirator device of claim 21, wherein the cone shaped baffle includes a wall that has a curved profile.

23. The respirator device of any one of claims 1-22, wherein the filter adapter includes a filter seat configured to receive the filter media component and being asymmetrically aligned with a port of the facepiece.

24. The respirator device of any one of claims 1-23, wherein the filter adapter includes an alignment feature to indicate correct alignment of the filter adapter to the facepiece.

25. The respirator device of claim 24, wherein the alignment features includes one or more ribs that protrude from the filter adapter.

26. The respirator device of any one of claims 1-25, wherein the filter grill includes one or more concentric ring features to provide loading support for the filter media component against exhalation pressure.

27. The respirator device of claim 26, wherein the one or more ring features include a ridge to compress the filter media circumferentially between the filter grill and the filter adapter.

28. The respirator device of any one of claims 1-27, wherein the filter retention mechanism includes one or more pairs of opposing interlocking bayonet-type ratcheting ramps, each pair including a bayonet-type ratcheting ramp provided by the filter adapter and another bayonet-type ratcheting ramp provided by the filter grill.

29. The respirator device of claim 28, wherein the filter adapter and the filter grill each include bayonet tabs that provide the ratcheting ramps, each bayonet tab including a ramp face having a saw-tooth like feature.

30. The respirator device of claim 29, wherein the filter adapter includes a cylindrical body and the bayonet tabs of the filter adapter extend radially outward from the cylindrical body, and wherein the filter grill includes a cylindrical wall and the bayonet tabs of the filter grill extend radially inward from the cylindrical wall.

31. The respirator device of any one of claims 1-30, further comprising one or more finger grip features at the filter adapter, the filter grill, or both.

32. The respirator device of any one of claims 1-31, further comprising one or more modular straps configured to couple to at least one of the filter adapter and the facepiece, the straps adjustable to wrap around the head of a person wearing the respirator device, the neck of the person wearing the respirator device, or both, to secure the respirator device to the face of the person.

33. The respirator device of any one of claims 1-32, wherein the filter adapter and the filter grill when coupled together form a modular filter component configured to encapsulate the filter media component.

34. The respirator device of claim 33, wherein the filter media component comprises a particulate filtering, organic vapor, acid, vapor, or oil filtering capability.

35. The respirator device of claim 34, wherein the modular filter component is configured to encapsulate more than one type of filter media component.

36. The respirator device of any one of claims 1-35, further comprising:
a microphone configured to detect an ambient noise level, wherein the microphone is configured to send an audio signal to a remote computing device.

37. The respirator device of any one of claims 1-36, further comprising:
an environmental sensor configured to detect an ambient air quality, wherein the environmental sensor is configured to send a sensor signal to a remote computing device.

38. The respirator device of claim 37, wherein the remote computing device comprises an IoT device.

39. The respirator device of claim 37 or 38, wherein the environmental sensor sends the sensor signal in real-time.

40. The respirator device of any one of claims 37-39, wherein the ambient air quality comprises an amount of aerosolized particulates.

41. The respirator device of any one of claims 1-36, further comprising:
a biosensor configured to detect one or more user conditions, wherein the biosensor is configured to send a sensor signal to a remote computing device.

42. The respirator device of claim 41, wherein the remote computing device comprises an IoT device.

43. The respirator device of claim 41 or 42, wherein the biosensor sends the sensor signal in real-time.

44. The respirator device of any one of claims 41-43, wherein the one or more user conditions comprises at least one of a temperature, breathing rate, breathing pressure, O2 level, CO2 level, relative humidity, moisture level, orientation, or motion.

45. A modular reusable respirator device comprising:
an elastomeric facepiece;
a filter adapter configured to couple to the facepiece;
a locking element configured to secure the elastomeric facepiece to the filter adapter by a facepiece retention mechanism, the facepiece retention mechanism including an interlocking bayonet-type ratcheting ramp configured to provide a sealing pressure;
a filter media component receivable in the filter adapter; and
a filter grill configured to couple to the filter adapter and secure the filter media element by a filter retention mechanism, the filter retention mechanism including an interlocking bayonet-type ratcheting ramp configured to provide a sealing pressure around the filter media component.

46. The respirator device of claim 45, further comprising one or more modular straps configured to couple to at least one of the filter adapter and the facepiece.

47. An interface system for a modular device, the device including an elastomeric facepiece and a device adapter, the interface system comprising:
an elastomeric facepiece including a facepiece port;
a device adapter configured to couple to the facepiece port;
a lock ring receivable in the facepiece port and configured to secure the facepiece to the filter adapter via a facepiece retention mechanism, the facepiece retention mechanism including an interlocking bayonet-type ratcheting ramp configured to provide a sealing pressure at the facepiece port.

48. The interface system of claim 47, wherein the facepiece retention mechanism includes one or more pairs of opposing interlocking bayonet-type ratcheting ramps, each pair including a bayonet-type ratcheting ramp provided by the lock ring and another bayonet-type ratcheting ramp provided by the device adapter.

49. The interface system of claim 48, wherein the lock ring and the device adapter each include bayonet tabs that provide the ratcheting ramps, each bayonet tab including a ramp face having a ratchet feature, optionally having a saw-tooth like, triangular, sinusoidal, or ridged geometry.

50. The interface system of claim 49, wherein the lock ring includes a cylindrical body and the bayonet tabs of the lock ring extend radially outward from the cylindrical body, and wherein the device adapter includes a cylindrical wall and the bayonet tabs of the device adapter extend radially inward from the cylindrical wall.

51. The interface system of claim 49 or 50, wherein the lock ring includes one or more radially oriented handles.

52. The interface system of claim 51, wherein the lock ring includes one or more spokes, optionally at least a portion of the spokes aligned with a portion of the bayonet tabs of the lock ring.

53. The interface system of any one of claims 47-52, wherein the modular device is a modular respirator device and the device adapter is a filter adapter.

54. The interface system of any one of claims 47-52, wherein the device adapter is configured to couple the facepiece to a filter component, a breathing tube, or a device having one or more device ports.

55. A modular facepiece for a device, the facepiece comprising:
an elastomeric facepiece body comprising:
an interfacing portion configured to seal to the face of a person wearing the respirator device, wherein the interfacing portion has a geometry with an outward curvature, the outward curvature allowing the interfacing portion to seal to the face of the person wearing the device by rolling back and increasing contact area between the facepiece and the face; and
a port configured to couple to a device adapter of the device.

56. The facepiece of claim 55, wherein the outward curvature comprises a curl circumferentially sweeping a perimeter of interfacing portion.

57. The facepiece of claim 55 or 56, wherein the elastomeric facepiece body comprises features that provide localized thickness to control stiffness of the facepiece.

58. The facepiece of claim 57, wherein the features that provide localized thickness include one or more ridges.

59. The facepiece of claim 58, wherein the one or more ridges are positioned between the port and the interfacing portion of the facepiece.

60. The facepiece of claim 59, wherein the one or more ridges generally extend away from the port and toward an edge of the interfacing portion of the facepiece.

61. The facepiece of claim 60, wherein the one or more ridges diminish in height, width, or both as the ridges extend from the port and toward the edge of the interfacing portion.

62. The facepiece of any one of claims 58-61, wherein the one or more ridges are integrally formed with the facepiece body.

63. The facepiece of any one of claims 57-62, wherein the features that provide localized thickness include a varying thickness of a wall of the facepiece body.

64. The facepiece of any one of claims 55-63, wherein the port includes an integrated O-ring feature defining a circular opening.

65. The facepiece of claim 64, wherein the port further includes a cylindrical wall concentrically aligned with the circular opening.

66. The facepiece of claim 65, wherein the facepiece includes an indexing feature to orient the facepiece with respect to the device adapter.

67. The facepiece of claim 66, wherein the indexing feature includes one or more protrusions at or near the port.

68. The facepiece of any one of claims 55-67, wherein the device is a modular respirator device.

69. A modular reusable respirator device comprising:
an elastomeric facepiece element;
a modular housing comprising a modular filter component configured to couple to the elastomeric facepiece element, the modular filter component comprising a filter retention mechanism, wherein the filter retention mechanism includes an interlocking bayonet-type ratcheting ramp configured to provide a sealing pressure around the modular filter component; and
one or more modular straps configured to couple to the modular housing or the elastomeric facepiece element.

70. The reusable respirator device of claim 69, wherein the modular filter component is configured to encapsulate a filtering medium.

71. The reusable respirator device of claim 70, wherein the filtering medium comprises a particulate filtering, organic vapor, acid, vapor, or oil filtering capability.

72. The reusable respirator device of claim 69, wherein the modular filter component is configured to encapsulate more than one type of filtering media.

73. The reusable respirator device of claim 69, further comprising a modular drinking tube.

74. The reusable respirator device of claim 69, further comprising:
a microphone configured to detect an ambient noise level, wherein the microphone is configured to send an audio signal to a remote computing device.

75. The reusable respirator device of claim 69, further comprising:
an environmental sensor configured to detect an ambient air quality, wherein the environmental sensor is configured to send a sensor signal to a remote computing device.

76. The reusable respirator device of claim 75, wherein the remote computing device comprises an IoT device.

77. The reusable respirator device of claim 75 or 76, wherein the environmental sensor sends the sensor signal in real-time.

78. The reusable respirator device of claim 75, wherein the ambient air quality comprises an amount of aerosolized particulates.

79. The reusable respirator device of claim 69, further comprising:
a biosensor configured to detect one or more user conditions, wherein the biosensor is configured to send a sensor signal to a remote computing device.

80. The reusable respirator device of claim 79, wherein the remote computing device comprises an IoT device.

81. The reusable respirator device of claim 79 or 80, wherein the biosensor sends the sensor signal in real-time.

82. The reusable respirator device of claim 79, wherein the one or more user conditions comprises at least one of a temperature, breathing rate, breathing pressure, O2 level, CO2 level, relative humidity, moisture level, orientation, or motion.

83. A respirator device comprising:
an elastomeric facepiece element;
a housing comprising a modular filter component configured to couple to the elastomeric facepiece element, the modular filter component comprising a filter retention mechanism, wherein the filter retention mechanism is configured to form a seal around the modular filter component; and
a sensor coupled to the elastomeric facepiece element or the housing.

84. The respirator device of claim 83, wherein the modular filter component is configured to encapsulate more than one type of filtering media, and further comprising a modular drinking tube or microphone.

85. The respirator device of claim 83 or 84, wherein the sensor is an environmental sensor configured to detect an ambient air quality level, and wherein the environmental sensor is configured to send a sensor signal to a remote computing device in real-time.

86. The respirator device of claim 85, wherein the remote computing device comprises an IoT device, and wherein the ambient air quality level comprises an amount of aerosolized particulates.

87. The respirator device of claim 83 or 84, wherein the sensor is a biosensor configured to detect one or more user conditions, wherein the biosensor is configured to send a sensor signal to a remote computing device in real-time, and wherein the remote computing device comprises an IoT device, and wherein the one or more user conditions comprises at least one of a temperature, breathing rate, amount of breathing pressure, O2 level, CO2 level, relative humidity, moisture level, orientation, or motion.

88. The respirator device of any one of claims 69-87, wherein the modular filter component comprises a filter adapter and a filter grill configured to couple to each other.

89. A computing system comprising:
a processing device; and
a non-transitory computer-readable medium communicatively coupled to the processing device and storing program code, the processing device configured to execute the program code and thereby perform operations comprising:
sampling a sensor signal from a sensor configured to sense an environmental or biometric condition associated with a modular respirator device;
analyzing sensor data associated with the sensor signal;
determining a change in the environmental or biometric condition based on a change in the sensor data over time; and
generating, for display, a notification based on the change in the environmental or biometric condition.

90. The respirator device of any one of claims 1-46 and 69-88 or facepiece of any one of claims 58-68, wherein the facepiece includes a single port, the single port being the port configured to couple to the adapter of the device.

91. A modular reusable respirator device comprising:
an elastomeric facepiece;
a filter adapter configured to couple to the facepiece;
a filter grill configured to couple to the filter adapter, the filter grill and the filter adapter cooperating to house a filter media component between the filter adapter and filter grill; and
an exhaust valve integrated into the filter adapter, oriented off-center and directing exhaust air generally in a direction of a wearer of the device.
